(19) United States
(12) Patent Application Publication
(10) Pub. No.: US 2025/0038572 A1
(43) Pub. Date: Jan. 30, 2025

(54) WIRELESS CHARGER FOR PLAYBACK DEVICES

(71) Applicant: Sonos, Inc., Goleta, CA (US)

(72) Inventors: Nicholas D'Amato, Santa Barbara, CA (US); Chadwick Souza, Boston, MA (US)

(21) Appl. No.: 18/918,236

(22) Filed: Oct. 17, 2024

Related U.S. Application Data
(63) Continuation of application No. 17/248,868, filed on Feb. 11, 2021.
(60) Provisional application No. 63/040,321, filed on Jun. 17, 2020.

(51) Int. Cl. H02J 50/00; H02J 50/10; H02J 50/90; H04R 1/10

(52) U.S. Cl. CPC H02J 50/005; H02J 50/10; H02J 50/90; H04R 1/1025; H02J 2310/22; H04R 2420/07

(57) ABSTRACT

Aspects of the present disclosure relate to wireless chargers for playback devices, such as portable playback devices.

### CROSS REFERENCE TO RELATED APPLICATIONS

This application is a continuation of and claims priority to co-pending U.S. patent application Ser. No. 17/248,868 filed on Feb. 11, 2021, which claims priority to U.S. Provisional Patent Application No. 63/040,321, filed on Jun. 17, 2020, titled “Wireless Charger for Playback Devices,” each of which is hereby incorporated herein by reference in its entirety.

### TECHNICAL FIELD

The present technology relates to consumer goods and, more particularly, to methods, systems, products, features, services, and other elements directed to media playback systems or some aspect thereof.

### BACKGROUND

Options for accessing and listening to digital audio in an out-loud setting were limited until in 2003, when SONOS, Inc. filed for one of its first patent applications, entitled “Method for Synchronizing Audio Playback between Multiple Networked Devices,” and began offering a media playback system for sale in 2005. The SONOS Wireless HiFi System enables people to experience music from many sources via one or more networked playback devices. Through a software control application installed on a smartphone, tablet, or computer, one can play what he or she wants in any room that has a networked playback device. Additionally, using a controller, for example, different songs can be streamed to each room that has a playback device, rooms can be grouped together for synchronous playback, or the same song can be heard in all rooms synchronously.

Given the ever-growing interest in digital media, there continues to be a need to develop consumer-accessible technologies to further enhance the listening experience.

### BRIEF DESCRIPTION OF THE DRAWINGS

Features, aspects, and advantages of the presently disclosed technology may be better understood with regard to the following description, appended claims, and accompanying drawings.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 2A is a functional block diagram of an example playback device.

FIG. 2B is an isometric diagram of an example housing of the playback device of FIG. 2A.

FIG. 2C is a diagram of another example housing for the playback device of FIG. 2A.

FIG. 2D is a diagram of another example housing for the playback device of FIG. 2A.

FIGS. 3A-3E are diagrams showing example playback device configurations in accordance with aspects of the disclosure.

FIG. 4A is a functional block diagram of an example controller device in accordance with aspects of the disclosure.

FIGS. 4B and 4C are controller interfaces in accordance with aspects of the disclosure.

FIG. 5 is a functional block diagram of certain components of an example wireless charger for a playback device in accordance with aspects of the disclosure.

FIG. 6A is a diagram showing an example arrangement of magnet assemblies in a triangular housing for a wireless charger in accordance with aspects of the disclosure.

FIG. 6B is a diagram showing an example arrangement of ferromagnetic materials in a triangular housing for a playback device in accordance with aspects of the disclosure.

FIG. 7 is a cross-sectional diagram of an example wireless charger and playback device in accordance with aspects of the present disclosure.

FIG. 8A is a diagram showing example housings for a playback device and a wireless charger that comprise mating surfaces in accordance with aspects of the present disclosure.

FIG. 8B is a diagram showing additional example housings for a playback device and a wireless charger that comprise mating surfaces in accordance with aspects of the present disclosure.

FIG. 9A is a diagram showing a playback device and a wireless charger in a first orientation in accordance with aspects of the present disclosure.

FIG. 9B is a diagram showing a playback device and a wireless charger in a second orientation in accordance with aspects of the present disclosure.

FIG. 10 is a diagram showing an example method performed by a playback device in accordance with aspects of the present disclosure.

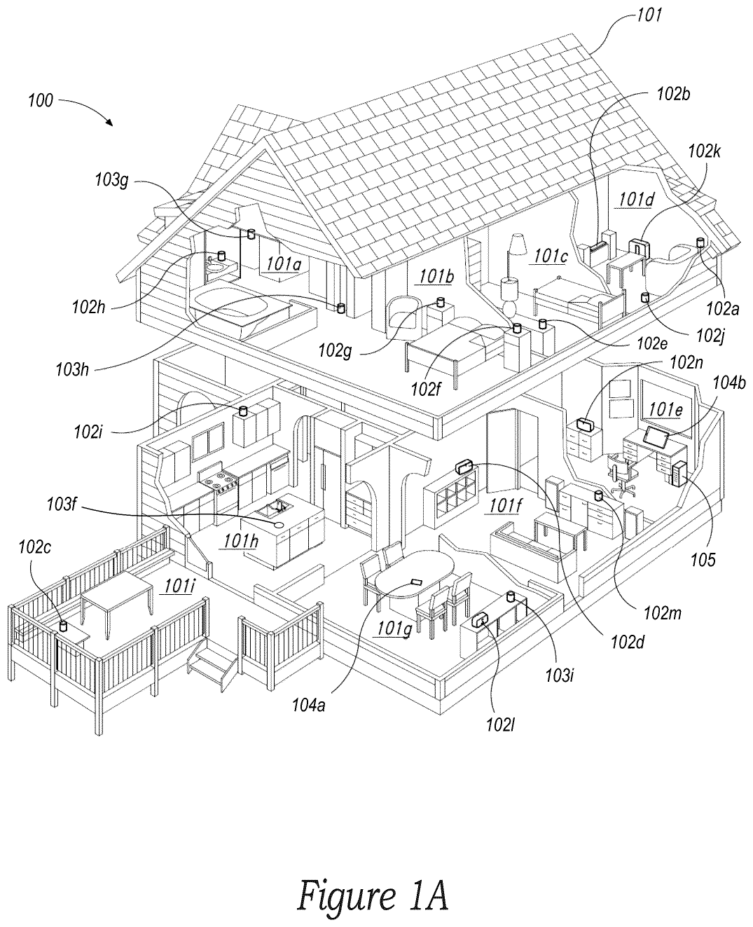

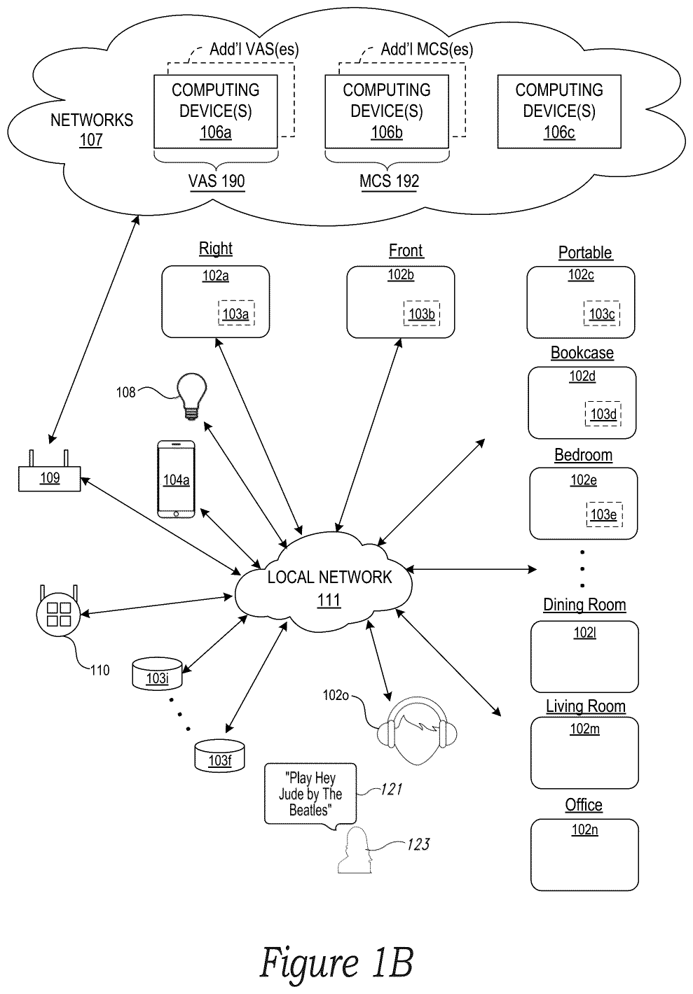

The drawings are for purposes of illustrating example embodiments, but it should be understood that the inventions are not limited to the arrangements and instrumentality shown in the drawings. In the drawings, identical reference numbers identify at least generally similar elements. To facilitate the discussion of any particular element, the most significant digit or digits of any reference number refers to the Figure in which that element is first introduced. For example, element 103a is first introduced and discussed with reference to FIG. 1A.

### DETAILED DESCRIPTION

### I. Overview

SONOS Inc. has been an innovator in the space of portable audio devices and associated accessories. For example, SONOS Inc. created the portable playback device SONOS MOVE and the associated docking accessory to facilitate recharging. Further, SONOS Inc. has developed technology to incorporate intelligence into a docking accessory for a portable playback device as described in U.S. Pat. No. 9,544,701, issued Jan. 10, 2017, titled “Base Properties in a Media Playback System” and U.S. Pat. No. 10,001,965, issued Jan. 18, 2018, titled “Playback System Join with Base,” each of which is hereby incorporated by reference in its entirety.

Building on prior innovations by SONOS Inc. in the portable audio device and associated accessories space, SONOS Inc. is reimaging the concept of a dedicating docking accessory (e.g., wireless charger) for a portable playback device to improve the user experience. In particular, conventional wireless chargers (e.g., conventional QI-compliant wireless chargers) typically are designed with a flat top-surface onto which a device with a wireless power receiver may be carefully placed by a user. The inventors have appreciated that such a design does not provide an easy mechanism to facilitate proper alignment with the playback device. For example, the user may need to reposition the device on the flat top-surface of the wireless charger until the device indicates that it is actually being charged. Further, the inventors have appreciated that such conventional designs do not support wireless charging in multiple orientations. For example, a bottom surface of a conventional wireless charger needs to be placed on a flat surface (e.g., a table, a desk, a nightstand, etc.) such that the top surface of the conventional wireless charger is parallel with the flat surface to enable wireless charging without the device falling off the wireless charger (e.g., and stop charging).

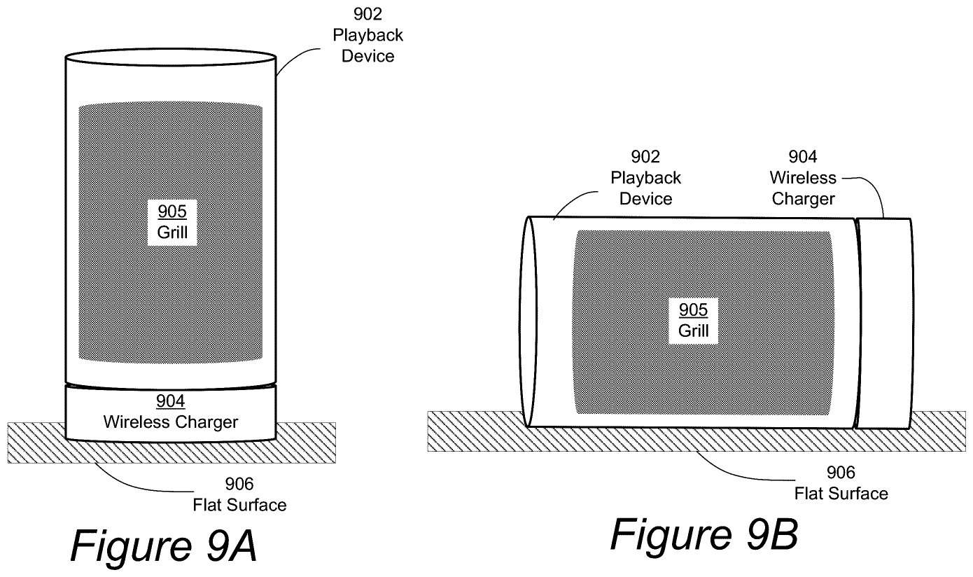

Accordingly, aspects of the present disclosure relate to an innovative wireless charger design for a playback device. The wireless charger is configured to operate (e.g., wirelessly charge) a playback device (or any other type of device such as a smartphone) in multiple orientations as shown in FIGS. 9A and 9B. For example, a playback device 902 (with a speaker grill 905 depicted for reference) may support a plurality of orientations relative to a flat surface 906 including a vertical orientation (shown in FIG. 9A) and/or a horizontal orientation (shown in FIG. 9B). As shown, the wireless charger 904 may be designed so as to remain attached (and/or operable) to the playback device 902 in at least two of the plurality of orientations supported by the playback device (e.g., both the vertical orientation shown in FIG. 9A and the horizontal orientation shown in FIG. 9B). Further, the wireless charger may be configured to facilitate alignment with the playback device such that a user does not have reposition the playback device on the wireless charger for the wireless power transfer to start.

In some examples, the wireless charger may comprise one or more magnet assemblies configured to facilitate alignment with the playback device. In these examples, the one or more magnet assemblies may be positioned outside of the wireless charging coil (e.g., disposed between an outer edge of the wireless charging coil and a lateral surface of a housing of the wireless charger) and attract one or more ferromagnetic materials (e.g., one or more ferromagnetic plates) and/or one or more magnet assemblies disposed in the playback device. For instance, the one or more magnet assemblies may be disposed proximate a mating surface of the wireless charger and attract one or more ferromagnetic materials (and/or one or more magnet assemblies) disposed proximate a respective mating surface of the playback device. The one or more magnet assemblies may be configured such that the attractive force on the ferromagnetic materials (and/or one or more magnet assemblies) in the playback device is sufficiently strong to keep the wireless charger in-contact with the playback device in multiple orientations. For example, the playback device may be positioned horizontally on a table such that the mating surface of the playback device is substantially perpendicular (e.g., perpendicular) to the table and the attractive force by the one or more magnet assemblies may be sufficiently strong to keep the respective mating surface of the wireless charger in-contact with the mating surface of the playback device (e.g., as shown in FIG. 9B).

In some instances, the wireless charger may comprise one or more components configured to transmit an identifier (e.g., a unique identifier) associated with the wireless charger to a device (e.g., placed on and/or being charged by the wireless charger). In such instances, the device may employ the received identifier to identify one or more characteristics of the wireless charger (e.g., manufacturer, serial number, external color, etc.). For example, the device may employ the received identifier to determine whether or not the wireless charger is compatible with the device. Additionally (or alternatively), the device may perform one or more operations when particular identifiers associated with specific wireless chargers are received. For example, a playback device may join a particular synchrony group when placed on a particular wireless charger. For instance, a user may have a stationary playback device and a wireless charger installed in their kitchen. In such an instance, a portable playback device that is compatible with the wireless charger may automatically join a synchrony group with the stationary playback device in the kitchen when that portable playback device is placed on the wireless charger installed in the kitchen (e.g., the portable playback device receives an identifier associated with that particular wireless charger).

It should be appreciated that a device may perform any of a variety of operations when an identifier associated with a particular wireless charger (or other accessory) is detected. For example, a device may perform one or more of the following operations: (1) join an existing synchrony group; (2) leave an existing synchrony group; (3) form a new synchrony group; (4) change one or more settings, such as one or more settings associated with audio playback (e.g., volume, balance, equalization, etc.); and/or (5) modify a user interface (e.g., modify a functionality assigned to a user interface element (including deactivating/activating the user interface element), present an image of the detected accessory on a display screen, etc.).

While some embodiments described herein may refer to functions performed by given actors, such as “users” and/or other entities, it should be understood that this description is for purposes of explanation only. The claims should not be interpreted to require action by any such example actor unless explicitly required by the language of the claims themselves.

### II. Example Operating Environment

FIGS. 1A and 1B illustrate an example configuration of a media playback system 100 (or “MPS 100”) in which one or more embodiments disclosed herein may be implemented. Referring first to FIG. 1A, the MPS 100 as shown is associated with an example home environment having a plurality of rooms and spaces, which may be collectively referred to as a “home environment,” “smart home,” or “environment 101.” The environment 101 comprises a household having several rooms, spaces, and/or playback zones, including a master bathroom 101a, a master bedroom 101b (referred to herein as “Nick's Room”), a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the MPS 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

Within these rooms and spaces, the MPS 100 includes one or more computing devices. Referring to FIGS. 1A and 1B together, such computing devices can include playback devices 102 (identified individually as playback devices 102a-102o), network microphone devices 103 (identified individually as “NMDs” 103a-102i), and controller devices 104a and 104b (collectively “controller devices 104”). Referring to FIG. 1B, the home environment may include additional and/or other computing devices, including local network devices, such as one or more smart illumination devices 108 (FIG. 1B), a smart thermostat 110, and a local computing device 105 (FIG. 1A). In embodiments described below, one or more of the various playback devices 102 may be configured as portable playback devices, while others may be configured as stationary playback devices. For example, the headphones 102o (FIG. 1B) are a portable playback device, while the playback device 102d on the bookcase may be a stationary device. As another example, the playback device 102c on the Patio may be a battery-powered device, which may allow it to be transported to various areas within the environment 101, and outside of the environment 101, when it is not plugged in to a wall outlet or the like.

With reference still to FIG. 1B, the various playback, network microphone, and controller devices 102-104 and/or other network devices of the MPS 100 may be coupled to one another via point-to-point connections and/or over other connections, which may be wired and/or wireless, via a local network 111 that may include a network router 109. For example, the playback device 102j in the Den 101d (FIG. 1A), which may be designated as the “Left” device, may have a point-to-point connection with the playback device 102a, which is also in the Den 101d and may be designated as the “Right” device. In a related embodiment, the Left playback device 102j may communicate with other network devices, such as the playback device 102b, which may be designated as the “Front” device, via a point-to-point connection and/or other connections via the local network 111. The local network 111 may be, for example, a network that interconnects one or more devices within a limited area (e.g., a residence, an office building, a car, an individual's workspace, etc.). The local network 111 may include, for example, one or more local area network (LANs) such as wireless local area networks (WLANs) (e.g., WI-FI networks, Z-WAVE networks, etc.) and/or one or more personal area networks (PANs) such as BLUETOOTH networks, wireless USB networks, ZIGBEE networks, and IRDA networks.

As further shown in FIG. 1B, the MPS 100 may be coupled to one or more remote computing devices 106 via a wide area network (“WAN”) 107. In some embodiments, each remote computing device 106 may take the form of one or more cloud servers. The remote computing devices 106 may be configured to interact with computing devices in the environment 101 in various ways. For example, the remote computing devices 106 may be configured to facilitate streaming and/or controlling playback of media content, such as audio, in the home environment 101.

In some implementations, the various playback devices, NMDs, and/or controller devices 102-104 may be communicatively coupled to at least one remote computing device associated with a voice assistant service (“VAS”) and at least one remote computing device associated with a media content service (“MCS”). For instance, in the illustrated example of FIG. 1B, remote computing devices 106a are associated with a VAS 190 and remote computing devices 106b are associated with an MCS 192. Although only a single VAS 190 and a single MCS 192 are shown in the example of FIG. 1B for purposes of clarity, the MPS 100 may be coupled to multiple, different VASes and/or MCSes. In some implementations, VASes may be operated by one or more of AMAZON, GOOGLE, APPLE, MICROSOFT, NUANCE, SONOS or other voice assistant providers. In some implementations, MCSes may be operated by one or more of SPOTIFY, PANDORA, AMAZON MUSIC, or other media content services.

As further shown in FIG. 1B, the remote computing devices 106 further include remote computing device 106c configured to perform certain operations, such as remotely facilitating media playback functions, managing device and system status information, directing communications between the devices of the MPS 100 and one or multiple VASes and/or MCSes, among other operations. In one example, the remote computing devices 106c provide cloud servers for one or more SONOS Wireless HiFi Systems.

In various implementations, one or more of the playback devices 102 may take the form of or include an on-board (e.g., integrated) network microphone device. For example, the playback devices 102a-e include or are otherwise equipped with corresponding NMDs 103a-e, respectively. A playback device that includes or is equipped with an NMD may be referred to herein interchangeably as a playback device or an NMD unless indicated otherwise in the description. In some cases, one or more of the NMDs 103 may be a stand-alone device. For example, the NMDs 103f and 103g may be stand-alone devices. A stand-alone NMD may omit components and/or functionality that is typically included in a playback device, such as a speaker or related electronics. For instance, in such cases, a stand-alone NMD may not produce audio output or may produce limited audio output (e.g., relatively low-quality audio output).

The various playback and network microphone devices 102 and 103 of the MPS 100 may each be associated with a unique name, which may be assigned to the respective devices by a user, such as during setup of one or more of these devices. For instance, as shown in the illustrated example of FIG. 1B, a user may assign the name “Bookcase” to playback device 102d because it is physically situated on a bookcase. Similarly, the NMD 103f may be assigned the named “Island” because it is physically situated on an island countertop in the Kitchen 101h (FIG. 1A). Some playback devices may be assigned names according to a zone or room, such as the playback devices 102e, 102l, 102m, and 102n, which are named “Bedroom,” “Dining Room,” “Living Room,” and “Office,” respectively. Further, certain playback devices may have functionally descriptive names. For example, the playback devices 102a and 102b are assigned the names “Right” and “Front,” respectively, because these two devices are configured to provide specific audio channels during media playback in the zone of the Den 101d (FIG. 1A). The playback device 102c in the Patio may be named portable because it is battery-powered and/or readily transportable to different areas of the environment 101. Other naming conventions are possible.

As discussed above, an NMD may detect and process sound from its environment, such as sound that includes background noise mixed with speech spoken by a person in the NMD's vicinity. For example, as sounds are detected by the NMD in the environment, the NMD may process the detected sound to determine if the sound includes speech that contains voice input intended for the NMD and ultimately a particular VAS. For example, the NMD may identify whether speech includes a wake word associated with a particular VAS.

In the illustrated example of FIG. 1B, the NMDs 103 are configured to interact with the VAS 190 over the local network 111 and/or the router 109. Interactions with the VAS 190 may be initiated, for example, when an NMD identifies in the detected sound a potential wake word. The identification causes a wake-word event, which in turn causes the NMD to begin transmitting detected-sound data to the VAS 190. In some implementations, the various local network devices 102-105 (FIG. 1A) and/or remote computing devices 106c of the MPS 100 may exchange various feedback, information, instructions, and/or related data with the remote computing devices associated with the selected VAS. Such exchanges may be related to or independent of transmitted messages containing voice inputs. In some embodiments, the remote computing device(s) and the media playback system 100 may exchange data via communication paths as described herein and/or using a metadata exchange channel as described in U.S. Patent Publication No. 2017-0242653 published Aug. 24, 2017, and titled “Voice Control of a Media Playback System,” which is herein incorporated by reference in its entirety.

Upon receiving the stream of sound data, the VAS 190 determines if there is voice input in the streamed data from the NMD, and if so the VAS 190 will also determine an underlying intent in the voice input. The VAS 190 may next transmit a response back to the MPS 100, which can include transmitting the response directly to the NMD that caused the wake-word event. The response is typically based on the intent that the VAS 190 determined was present in the voice input. As an example, in response to the VAS 190 receiving a voice input with an utterance to “Play Hey Jude by The Beatles,” the VAS 190 may determine that the underlying intent of the voice input is to initiate playback and further determine that intent of the voice input is to play the particular song “Hey Jude.” After these determinations, the VAS 190 may transmit a command to a particular MCS 192 to retrieve content (i.e., the song “Hey Jude”), and that MCS 192, in turn, provides (e.g., streams) this content directly to the MPS 100 or indirectly via the VAS 190. In some implementations, the VAS 190 may transmit to the MPS 100 a command that causes the MPS 100 itself to retrieve the content from the MCS 192.

In certain implementations, NMDs may facilitate arbitration amongst one another when voice input is identified in speech detected by two or more NMDs located within proximity of one another. For example, the NMD-equipped playback device 102d in the environment 101 (FIG. 1A) is in relatively close proximity to the NMD-equipped Living Room playback device 102m, and both devices 102d and 102m may at least sometimes detect the same sound. In such cases, this may require arbitration as to which device is ultimately responsible for providing detected-sound data to the remote VAS. Examples of arbitrating between NMDs may be found, for example, in previously referenced U.S. Patent Publication No. 2017-0242653.

In certain implementations, an NMD may be assigned to, or otherwise associated with, a designated or default playback device that may not include an NMD. For example, the Island NMD 103f in the Kitchen 101h (FIG. 1A) may be assigned to the Dining Room playback device 102l, which is in relatively close proximity to the Island NMD 103f. In practice, an NMD may direct an assigned playback device to play audio in response to a remote VAS receiving a voice input from the NMD to play the audio, which the NMD might have sent to the VAS in response to a user speaking a command to play a certain song, album, playlist, etc. Additional details regarding assigning NMDs and playback devices as designated or default devices may be found, for example, in previously referenced U.S. Patent Publication No. 2017-0242653.

Further aspects relating to the different components of the example MPS 100 and how the different components may interact to provide a user with a media experience may be found in the following sections. While discussions herein may generally refer to the example MPS 100, technologies described herein are not limited to applications within, among other things, the home environment described above. For instance, the technologies described herein may be useful in other home environment configurations comprising more or fewer of any of the playback, network microphone, and/or controller devices 102-104. For example, the technologies herein may be utilized within an environment having a single playback device 102 and/or a single NMD 103. In some examples of such cases, the local network 111 (FIG. 1B) may be eliminated and the single playback device 102 and/or the single NMD 103 may communicate directly with the remote computing devices 106a-d. In some embodiments, a telecommunication network (e.g., an LTE network, a 5G network, etc.) may communicate with the various playback, network microphone, and/or controller devices 102-104 independent of the local network 111.

While specific implementations of MPS's have been described above with respect to FIGS. 1A and 1B, there are numerous configurations of MPS's, including, but not limited to, those that do not interact with remote services, systems that do not include controllers, and/or any other configuration as appropriate to the requirements of a given application.

### a. Example Playback & Network Microphone Devices

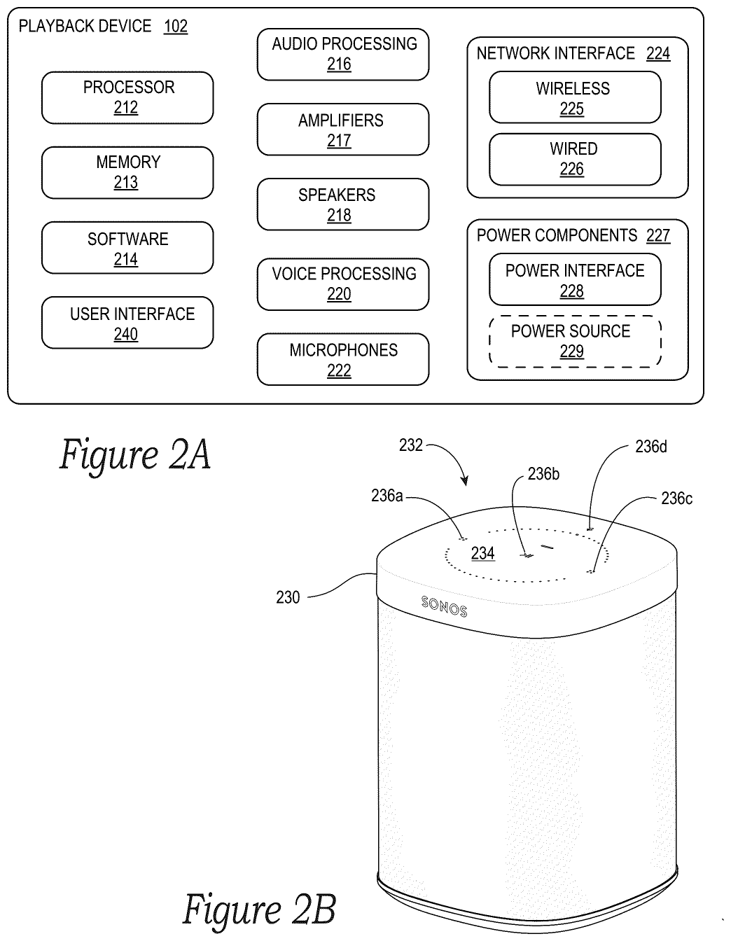

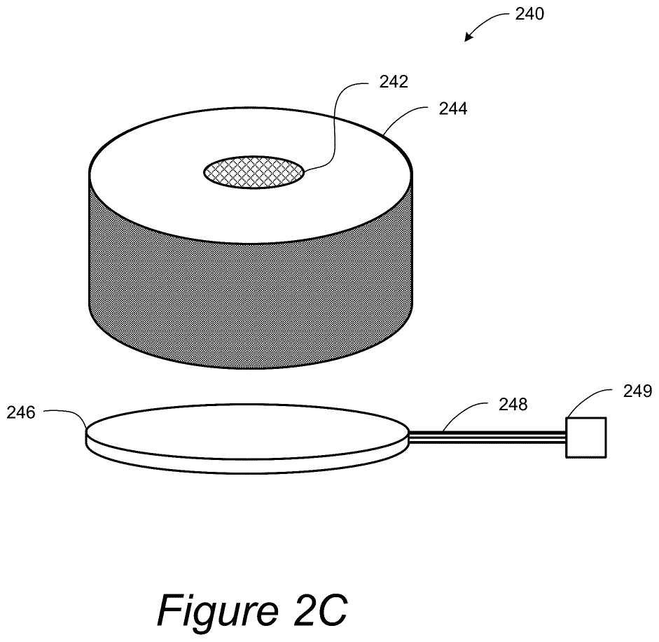

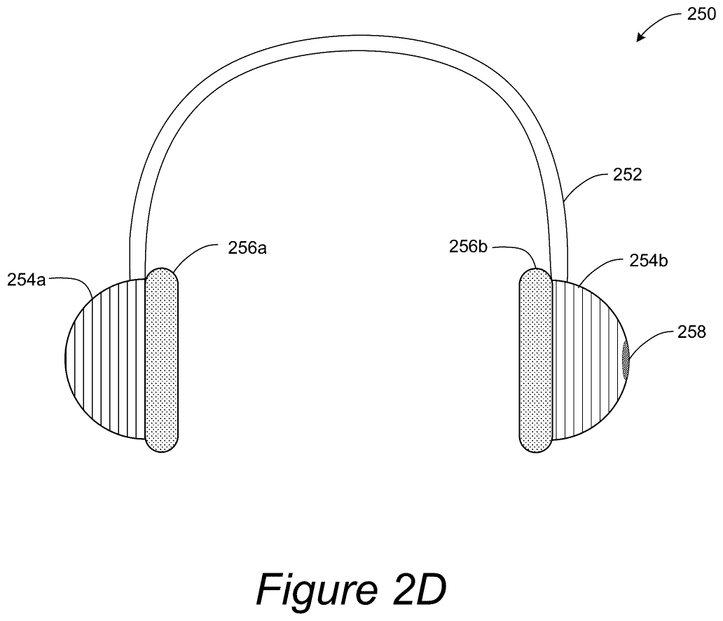

FIG. 2A is a functional block diagram illustrating certain aspects of one of the playback devices 102 of the MPS 100 of FIGS. 1A and 1B. As shown, the playback device 102 includes various components, each of which is discussed in further detail below, and the various components of the playback device 102 may be operably coupled to one another via a system bus, communication network, or some other connection mechanism. In the illustrated example of FIG. 2A, the playback device 102 may be referred to as an “NMD-equipped” playback device because it includes components that support the functionality of an NMD, such as one of the NMDs 103 shown in FIG. 1A.

As shown, the playback device 102 includes at least one processor 212, which may be a clock-driven computing component configured to process input data according to instructions stored in memory 213. The memory 213 may be a tangible, non-transitory, computer-readable medium configured to store instructions that are executable by the processor 212. For example, the memory 213 may be data storage that can be loaded with software code 214 that is executable by the processor 212 to achieve certain functions.

In one example, these functions may involve the playback device 102 retrieving audio data from an audio source, which may be another playback device. In another example, the functions may involve the playback device 102 sending audio data, detected-sound data (e.g., corresponding to a voice input), and/or other information to another device on a network via at least one network interface 224. In yet another example, the functions may involve the playback device 102 causing one or more other playback devices to synchronously playback audio with the playback device 102. In yet a further example, the functions may involve the playback device 102 facilitating being paired or otherwise bonded with one or more other playback devices to create a multi-channel audio environment. Numerous other example functions are possible, some of which are discussed below.

As just mentioned, certain functions may involve the playback device 102 synchronizing playback of audio content with one or more other playback devices. During synchronous playback, a listener may not perceive time-delay differences between playback of the audio content by the synchronized playback devices. U.S. Pat. No. 8,234,395 filed on Apr. 4, 2004, and titled “System and method for synchronizing operations among a plurality of independently clocked digital data processing devices,” which is hereby incorporated by reference in its entirety, provides in more detail some examples for audio playback synchronization among playback devices. To facilitate audio playback, the playback device 102 includes audio processing components 216 that are generally configured to process audio prior to the playback device 102 rendering the audio. In this respect, the audio processing components 216 may include one or more digital-to-analog converters (“DAC”), one or more audio preprocessing components, one or more audio enhancement components, one or more digital signal processors (“DSPs”), and so on. In some implementations, one or more of the audio processing components 216 may be a subcomponent of the processor 212. In operation, the audio processing components 216 receive analog and/or digital audio and process and/or otherwise intentionally alter the audio to produce audio signals for playback.

The produced audio signals may then be provided to one or more audio amplifiers 217 for amplification and playback through one or more speakers 218 operably coupled to the amplifiers 217. The audio amplifiers 217 may include components configured to amplify audio signals to a level for driving one or more of the speakers 218.

Each of the speakers 218 may include an individual transducer (e.g., a “driver”) or the speakers 218 may include a complete speaker system involving an enclosure with one or more drivers. A particular driver of a speaker 218 may include, for example, a subwoofer (e.g., for low frequencies), a mid-range driver (e.g., for middle frequencies), and/or a tweeter (e.g., for high frequencies). In some cases, a transducer may be driven by an individual corresponding audio amplifier of the audio amplifiers 217. In some implementations, a playback device may not include the speakers 218, but instead may include a speaker interface for connecting the playback device to external speakers. In certain embodiments, a playback device may include neither the speakers 218 nor the audio amplifiers 217, but instead may include an audio interface (not shown) for connecting the playback device to an external audio amplifier or audio-visual receiver.

In addition to producing audio signals for playback by the playback device 102, the audio processing components 216 may be configured to process audio to be sent to one or more other playback devices, via the network interface 224, for playback. In example scenarios, audio content to be processed and/or played back by the playback device 102 may be received from an external source, such as via an audio line-in interface (e.g., an auto-detecting 3.5 mm audio line-in connection) of the playback device 102 (not shown) or via the network interface 224, as described below.

As shown, the at least one network interface 224, may take the form of one or more wireless interfaces 225 and/or one or more wired interfaces 226. A wireless interface may provide network interface functions for the playback device 102 to wirelessly communicate with other devices (e.g., other playback device(s), NMD(s), and/or controller device(s)) in accordance with a communication protocol (e.g., any wireless standard including IEEE 802.11a, 802.11b, 802.11 g, 802.11n, 802.11ac, 802.11ad, 802.11af, 802.11ah, 802.11ai, 802.11aj, 802.11aq, 802.11ax, 802.11ay, 802.15, BLUETOOTH, 4G mobile communication standard, 5G mobile communication standard, and so on). A wired interface may provide network interface functions for the playback device 102 to communicate over a wired connection with other devices in accordance with a communication protocol (e.g., IEEE 802.3). While the network interface 224 shown in FIG. 2A includes both wired and wireless interfaces, the playback device 102 may in some implementations include only wireless interface(s) or only wired interface(s).

In general, the network interface 224 facilitates data flow between the playback device 102 and one or more other devices on a data network. For instance, the playback device 102 may be configured to receive audio content over the data network from one or more other playback devices, network devices within a LAN, and/or audio content sources over a WAN, such as the Internet. In one example, the audio content and other signals transmitted and received by the playback device 102 may be transmitted in the form of digital packet data comprising an Internet Protocol (IP)-based source address and IP-based destination addresses. In such a case, the network interface 224 may be configured to parse the digital packet data such that the data destined for the playback device 102 is properly received and processed by the playback device 102.

As shown in FIG. 2A, the playback device 102 also includes voice processing components 220 that are operably coupled to one or more microphones 222. The microphones 222 are configured to detect sound (i.e., acoustic waves) in the environment of the playback device 102, which is then provided to the voice processing components 220. More specifically, each microphone 222 is configured to detect sound and convert the sound into a digital or analog signal representative of the detected sound, which can then cause the voice processing component 220 to perform various functions based on the detected sound, as described in greater detail below. In one implementation, the microphones 222 are arranged as an array of microphones (e.g., an array of six microphones). In some implementations, the playback device 102 includes more than six microphones (e.g., eight microphones or twelve microphones) or fewer than six microphones (e.g., four microphones, two microphones, or a single microphones).

In operation, the voice-processing components 220 are generally configured to detect and process sound received via the microphones 222, identify potential voice input in the detected sound, and extract detected-sound data to enable a VAS, such as the VAS 190 (FIG. 1B), to process voice input identified in the detected-sound data. The voice processing components 220 may include one or more analog-to-digital converters, an acoustic echo canceller (“AEC”), a spatial processor (e.g., one or more multi-channel Wiener filters, one or more other filters, and/or one or more beam former components), one or more buffers (e.g., one or more circular buffers), one or more wake-word engines, one or more voice extractors, and/or one or more speech processing components (e.g., components configured to recognize a voice of a particular user or a particular set of users associated with a household), among other example voice processing components. In example implementations, the voice processing components 220 may include or otherwise take the form of one or more DSPs or one or more modules of a DSP. In this respect, certain voice processing components 220 may be configured with particular parameters (e.g., gain and/or spectral parameters) that may be modified or otherwise tuned to achieve particular functions. In some implementations, one or more of the voice processing components 220 may be a subcomponent of the processor 212.

In some implementations, the voice-processing components 220 may detect and store a user's voice profile, which may be associated with a user account of the MPS 100. For example, voice profiles may be stored as and/or compared to variables stored in a set of command information or data table. The voice profile may include aspects of the tone or frequency of a user's voice and/or other unique aspects of the user's voice, such as those described in previously-referenced U.S. Patent Publication No. 2017-0242653.

As further shown in FIG. 2A, the playback device 102 also includes power components 227. The power components 227 may include at least an external power source interface 228, which may be coupled to a power source (not shown) via a power cable or the like that physically connects the playback device 102 to an electrical outlet or some other external power source. Other power components may include, for example, transformers, converters, and like components configured to format electrical power.

In some implementations, the power components 227 of the playback device 102 may additionally include an internal power source 229 (e.g., one or more batteries) configured to power the playback device 102 without a physical connection to an external power source. When equipped with the internal power source 229, the playback device 102 may operate independent of an external power source. In some such implementations, the external power source interface 228 may be configured to facilitate charging the internal power source 229. As discussed before, a playback device comprising an internal power source may be referred to herein as a “portable playback device.” Those portable playback devices that weigh no more than fifty ounces (e.g., between three ounces and fifty ounces, between five ounces and fifty ounces, between ten ounces and fifty ounces, between ten ounces and twenty-five ounces, etc.) may be referred to herein as an “ultra-portable playback device.” Those playback devices that operate using an external power source instead of an internal power source may be referred to herein as a “stationary playback device,” although such a device may in fact be moved around a home or other environment.

The playback device 102 may further include a user interface 240 that may facilitate user interactions independent of or in conjunction with user interactions facilitated by one or more of the controller devices 104. In various embodiments, the user interface 240 includes one or more physical buttons and/or supports graphical interfaces provided on touch sensitive screen(s) and/or surface(s), among other possibilities, for a user to directly provide input. The user interface 240 may further include one or more of lights (e.g., LEDs) and the speakers to provide visual and/or audio feedback to a user.

As an illustrative example, FIG. 2B shows an example housing 230 of the playback device 102 that includes a user interface in the form of a control area 232 at a top portion 234 of the housing 230. The control area 232 includes buttons 236a-c for controlling audio playback, volume level, and other functions. The control area 232 also includes a button 236d for toggling the microphones 222 to either an on state or an off state.

As further shown in FIG. 2B, the control area 232 is at least partially surrounded by apertures formed in the top portion 234 of the housing 230 through which the microphones 222 (not visible in FIG. 2B) receive the sound in the environment of the playback device 102. The microphones 222 may be arranged in various positions along and/or within the top portion 234 or other areas of the housing 230 so as to detect sound from one or more directions relative to the playback device 102.

As mentioned above, the playback device 102 may be constructed as a portable playback device, such as an ultra-portable playback device, that comprises an internal power source. FIG. 2C shows an example housing 240 for such a portable playback device. As shown, the housing 240 of the portable playback device includes a user interface in the form of a control area 242 at a top portion 244 of the housing 240. The control area 242 may include a capacitive touch sensor for controlling audio playback, volume level, and other functions. The housing 240 of the portable playback device may be configured to engage with a dock 246 that is connected to an external power source via cable 248 (e.g., a USB cable) coupled to a power adapter 249 (e.g., a power adapter that converts power from a wall outlet to a USB port). The dock 246 may be configured to provide power to the portable playback device to recharge an internal battery. In some embodiments, the dock 246 may comprise a set of one or more conductive contacts (not shown) positioned on the top of the docket 246 that engage with conductive contacts on the bottom of the housing 240 (not shown). In other embodiments, the dock 246 may provide power from the cable 248 to the portable playback device without the use of conductive contacts. For example, the dock 246 may wirelessly charge the portable playback device via one or more inductive coils (e.g., consistent with the QI wireless charging standard) integrated into each of the dock 246 and the portable playback device. Additionally, the dock 246 may comprise one or more mechanisms for communicating with the playback device using, for example, Near Field Communication (NFC) and/or BLUETOOTH communication.

In some embodiments, the playback device 102 may take the form of a wired and/or wireless headphone (e.g., an over-ear headphone, an on-ear headphone, or an in-ear headphone). For instance, FIG. 2D shows an example housing 250 for such an implementation of the playback device 102. As shown, the housing 250 includes a headband 252 that couples a first earpiece 254a to a second earpiece 254b. Each of the earpieces 254a and 254b may house any portion of the electronic components in the playback device, such as one or more speakers. Further, one or more of the earpieces 254a and 254b may include a control area 258 for controlling audio playback, volume level, and other functions. The control area 258 may comprise any combination of the following: a capacitive touch sensor, a button, a switch, and a dial. As shown in FIG. 2D, the housing 250 may further include ear cushions 256a and 256b that are coupled to earpieces 254a and 254b, respectively. The ear cushions 256a and 256b may provide a soft barrier between the head of a user and the earpieces 254a and 254b, respectively, to improve user comfort and/or provide acoustic isolation from the ambient (e.g., passive noise reduction (PNR)). In some implementations, the wired and/or wireless headphones may be ultra-portable playback devices that are powered by an internal energy source and weigh less than fifty ounces.

It should be appreciated that the playback device 102 may take the form of other wearable devices separate and apart from a headphone. Wearable devices may include those devices configured to be worn about a portion of a subject (e.g., a head, a neck, a torso, an arm, a wrist, a finger, a leg, an ankle, etc.). For example, the playback device 102 may take the form of a pair of glasses including a frame front (e.g., configured to hold one or more lenses), a first temple rotatably coupled to the frame front, and a second temple rotatable coupled to the frame front. In this example, the pair of glasses may comprise one or more transducers integrated into at least one of the first and second temples and configured to project sound towards an ear of the subject.

While specific implementations of playback and network microphone devices have been described above with respect to FIGS. 2A, 2B, 2C, and 2D, there are numerous configurations of devices, including, but not limited to, those having no UI, microphones in different locations, multiple microphone arrays positioned in different arrangements, and/or any other configuration as appropriate to the requirements of a given application. For example, UIs and/or microphone arrays can be implemented in other playback devices and/or computing devices rather than those described herein. Further, although a specific example of playback device 102 is described with reference to MPS 100, one skilled in the art will recognize that playback devices as described herein can be used in a variety of different environments, including (but not limited to) environments with more and/or fewer elements, without departing from this invention. Likewise, MPS's as described herein can be used with various different playback devices.

By way of illustration, SONOS, Inc. presently offers (or has offered) for sale certain playback devices that may implement certain of the embodiments disclosed herein, including a “SONOS ONE,” “PLAY:1,” “PLAY:3,” “PLAY:5,” “PLAYBAR,” “AMP,” “CONNECT:AMP,” “PLAYBASE,” “BEAM,” “CONNECT,” and “SUB.” Any other past, present, and/or future playback devices may additionally or alternatively be used to implement the playback devices of example embodiments disclosed herein. Additionally, it should be understood that a playback device is not limited to the examples illustrated in FIG. 2A, 2B, 2C, or 2D or to the SONOS product offerings. For example, a playback device may be integral to another device or component such as a television, a lighting fixture, or some other device for indoor or outdoor use.

### b. Example Playback Device Configurations

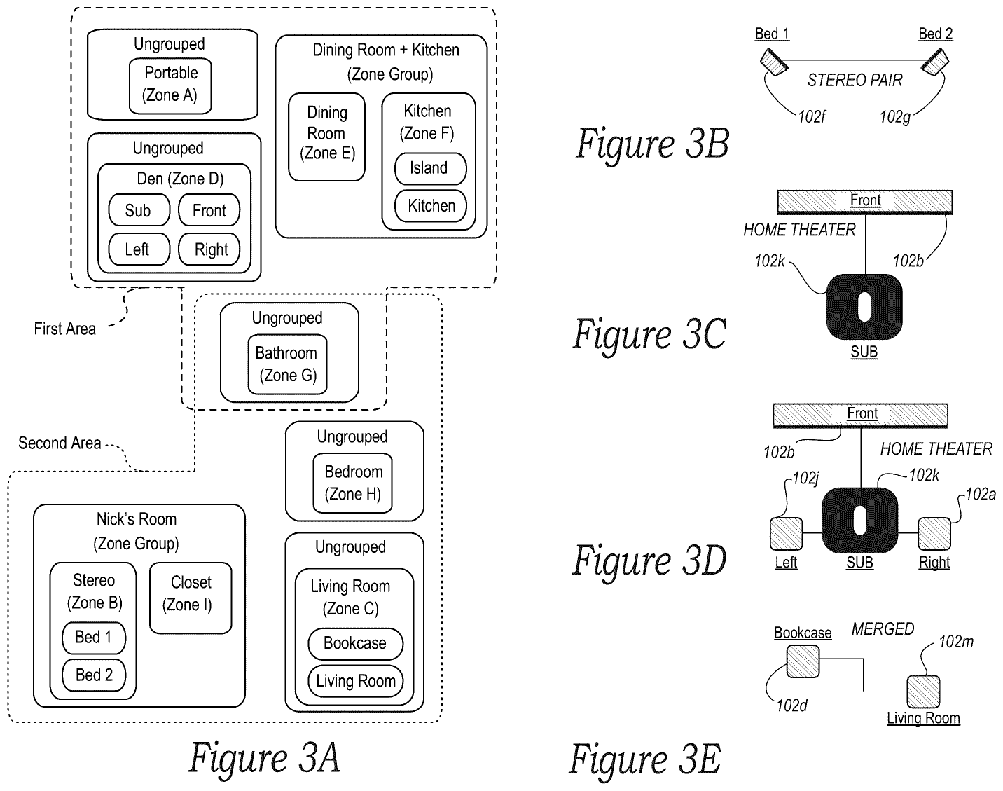

FIGS. 3A-3E show example configurations of playback devices. Referring first to FIG. 3A, in some example instances, a single playback device may belong to a zone. For example, the playback device 102c (FIG. 1A) on the Patio may belong to Zone A. In some implementations described below, multiple playback devices may be “bonded” to form a “bonded pair,” which together form a single zone. For example, the playback device 102f (FIG. 1A) named “Bed 1” in FIG. 3A may be bonded to the playback device 102g (FIG. 1A) named “Bed 2” in FIG. 3A to form Zone B. Bonded playback devices may have different playback responsibilities (e.g., channel responsibilities). In another implementation described below, multiple playback devices may be merged to form a single zone. For example, the playback device 102d named “Bookcase” may be merged with the playback device 102m named “Living Room” to form a single Zone C. The merged playback devices 102d and 102m may not be specifically assigned different playback responsibilities. That is, the merged playback devices 102d and 102m may, aside from playing audio content in synchrony, each play audio content as they would if they were not merged.

For purposes of control, each zone in the MPS 100 may be represented as a single user interface (“UI”) entity. For example, as displayed by the controller devices 104, Zone A may be provided as a single entity named “Portable,” Zone B may be provided as a single entity named “Stereo,” and Zone C may be provided as a single entity named “Living Room.”

In various embodiments, a zone may take on the name of one of the playback devices belonging to the zone. For example, Zone C may take on the name of the Living Room device 102m (as shown). In another example, Zone C may instead take on the name of the Bookcase device 102d. In a further example, Zone C may take on a name that is some combination of the Bookcase device 102d and Living Room device 102m. The name that is chosen may be selected by a user via inputs at a controller device 104. In some embodiments, a zone may be given a name that is different than the device(s) belonging to the zone. For example, Zone B in FIG. 3A is named “Stereo” but none of the devices in Zone B have this name. In one aspect, Zone B is a single UI entity representing a single device named “Stereo,” composed of constituent devices “Bed 1” and “Bed 2.” In one implementation, the Bed 1 device may be playback device 102f in the master bedroom 101h (FIG. 1A) and the Bed 2 device may be the playback device 102g also in the master bedroom 101h (FIG. 1A).

As noted above, playback devices that are bonded may have different playback responsibilities, such as playback responsibilities for certain audio channels. For example, as shown in FIG. 3B, the Bed 1 and Bed 2 devices 102f and 102g may be bonded so as to produce or enhance a stereo effect of audio content. In this example, the Bed 1 playback device 102f may be configured to play a left channel audio component, while the Bed 2 playback device 102g may be configured to play a right channel audio component. In some implementations, such stereo bonding may be referred to as “pairing.”

Additionally, playback devices that are configured to be bonded may have additional and/or different respective speaker drivers. As shown in FIG. 3C, the playback device 102b named “Front” may be bonded with the playback device 102k named “SUB.” The Front device 102b may render a range of mid to high frequencies, and the SUB device 102k may render low frequencies as, for example, a subwoofer. When unbonded, the Front device 102b may be configured to render a full range of frequencies. As another example, FIG. 3D shows the Front and SUB devices 102b and 102k further bonded with Right and Left playback devices 102a and 102j, respectively. In some implementations, the Right and Left devices 102a and 102j may form surround or “satellite” channels of a home theater system. The bonded playback devices 102a, 102b, 102j, and 102k may form a single Zone D (FIG. 3A).

In some implementations, playback devices may also be “merged.” In contrast to certain bonded playback devices, playback devices that are merged may not have assigned playback responsibilities, but may each render the full range of audio content that each respective playback device is capable of. Nevertheless, merged devices may be represented as a single UI entity (i.e., a zone, as discussed above). For instance, FIG. 3E shows the playback devices 102d and 102m in the Living Room merged, which would result in these devices being represented by the single UI entity of Zone C. In one embodiment, the playback devices 102d and 102m may playback audio in synchrony, during which each outputs the full range of audio content that each respective playback device 102d and 102m is capable of rendering.

In some embodiments, a stand-alone NMD may be in a zone by itself. For example, the NMD 103h from FIG. 1A is named “Closet” and forms Zone I in FIG. 3A. An NMD may also be bonded or merged with another device so as to form a zone. For example, the NMD device 103f named “Island” may be bonded with the playback device 102i Kitchen, which together form Zone F, which is also named “Kitchen.” Additional details regarding assigning NMDs and playback devices as designated or default devices may be found, for example, in previously referenced U.S. Patent Publication No. 2017-0242653. In some embodiments, a stand-alone NMD may not be assigned to a zone.

Zones of individual, bonded, and/or merged devices may be arranged to form a set of playback devices that playback audio in synchrony. Such a set of playback devices may be referred to as a “group,” “zone group,” “synchrony group,” or “playback group.” In response to inputs provided via a controller device 104, playback devices may be dynamically grouped and ungrouped to form new or different groups that synchronously play back audio content. For example, referring to FIG. 3A, Zone A may be grouped with Zone B to form a zone group that includes the playback devices of the two zones. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Grouped and bonded devices are example types of associations between portable and stationary playback devices that may be caused in response to a trigger event, as discussed above and described in greater detail below.

In various implementations, the zones in an environment may be assigned a particular name, which may be the default name of a zone within a zone group or a combination of the names of the zones within a zone group, such as “Dining Room+Kitchen,” as shown in FIG. 3A. In some embodiments, a zone group may be given a unique name selected by a user, such as “Nick's Room,” as also shown in FIG. 3A. The name “Nick's Room” may be a name chosen by a user over a prior name for the zone group, such as the room name “Master Bedroom.”

Referring back to FIG. 2A, certain data may be stored in the memory 213 as one or more state variables that are periodically updated and used to describe the state of a playback zone, the playback device(s), and/or a zone group associated therewith. The memory 213 may also include the data associated with the state of the other devices of the media playback system 100, which may be shared from time to time among the devices so that one or more of the devices have the most recent data associated with the system.

In some embodiments, the memory 213 of the playback device 102 may store instances of various variable types associated with the states. Variables instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, in FIG. 1A, identifiers associated with the Patio may indicate that the Patio is the only playback device of a particular zone and not in a zone group. Identifiers associated with the Living Room may indicate that the Living Room is not grouped with other zones but includes bonded playback devices 102a, 102b, 102j, and 102k. Identifiers associated with the Dining Room may indicate that the Dining Room is part of Dining Room+Kitchen group and that devices 103f and 102i are bonded. Identifiers associated with the Kitchen may indicate the same or similar information by virtue of the Kitchen being part of the Dining Room+Kitchen zone group. Other example zone variables and identifiers are described below.

In yet another example, the MPS 100 may include variables or identifiers representing other associations of zones and zone groups, such as identifiers associated with Areas, as shown in FIG. 3A. An Area may involve a cluster of zone groups and/or zones not within a zone group. For instance, FIG. 3A shows a first area named “First Area” and a second area named “Second Area.” The First Area includes zones and zone groups of the Patio, Den, Dining Room, Kitchen, and Bathroom. The Second Area includes zones and zone groups of the Bathroom, Nick's Room, Bedroom, and Living Room. In one aspect, an Area may be used to invoke a cluster of zone groups and/or zones that share one or more zones and/or zone groups of another cluster. In this respect, such an Area differs from a zone group, which does not share a zone with another zone group. Further examples of techniques for implementing Areas may be found, for example, in U.S. Patent Publication No. 2018-0107446 published Apr. 19, 2018 and titled “Room Association Based on Name,” and U.S. Pat. No. 8,483,853 filed Sep. 11, 2007, and titled “Controlling and manipulating groupings in a multi-zone media system,” each of which is incorporated herein by reference in its entirety. In some embodiments, the MPS 100 may not implement Areas, in which case the system may not store variables associated with Areas.

The memory 213 may be further configured to store other data. Such data may pertain to audio sources accessible by the playback device 102 or a playback queue that the playback device (or some other playback device(s)) may be associated with. In embodiments described below, the memory 213 is configured to store a set of command data for selecting a particular VAS when processing voice inputs.

During operation, one or more playback zones in the environment of FIG. 1A may each be playing different audio content. For instance, the user may be grilling in the Patio zone and listening to hip hop music being played by the playback device 102c, while another user may be preparing food in the Kitchen zone and listening to classical music being played by the playback device 102i. In another example, a playback zone may play the same audio content in synchrony with another playback zone. For instance, the user may be in the Office zone where the playback device 102n is playing the same hip-hop music that is being playing by playback device 102c in the Patio zone. In such a case, playback devices 102c and 102n may be playing the hip-hop in synchrony such that the user may seamlessly (or at least substantially seamlessly) enjoy the audio content that is being played out-loud while moving between different playback zones. Synchronization among playback zones may be achieved in a manner similar to that of synchronization among playback devices, as described in previously referenced U.S. Pat. No. 8,234,395.

As suggested above, the zone configurations of the MPS 100 may be dynamically modified. As such, the MPS 100 may support numerous configurations. For example, if a user physically moves one or more playback devices to or from a zone, the MPS 100 may be reconfigured to accommodate the change(s). For instance, if the user physically moves the playback device 102c from the Patio zone to the Office zone, the Office zone may now include both the playback devices 102c and 102n. In some cases, the user may pair or group the moved playback device 102c with the Office zone and/or rename the players in the Office zone using, for example, one of the controller devices 104 and/or voice input. As another example, if one or more playback devices 102 are moved to a particular space in the home environment that is not already a playback zone, the moved playback device(s) may be renamed or associated with a playback zone for the particular space.

Further, different playback zones of the MPS 100 may be dynamically combined into zone groups or split up into individual playback zones. For example, the Dining Room zone and the Kitchen zone may be combined into a zone group for a dinner party such that playback devices 102i and 102l may render audio content in synchrony. As another example, bonded playback devices in the Den zone may be split into (i) a television zone and (ii) a separate listening zone. The television zone may include the Front playback device 102b. The listening zone may include the Right, Left, and SUB playback devices 102a, 102j, and 102k, which may be grouped, paired, or merged, as described above. Splitting the Den zone in such a manner may allow one user to listen to music in the listening zone in one area of the living room space, and another user to watch the television in another area of the living room space. In a related example, a user may utilize either of the NMD 103a or 103b (FIG. 1B) to control the Den zone before it is separated into the television zone and the listening zone. Once separated, the listening zone may be controlled, for example, by a user in the vicinity of the NMD 103a, and the television zone may be controlled, for example, by a user in the vicinity of the NMD 103b. As described above, however, any of the NMDs 103 may be configured to control the various playback and other devices of the MPS 100.

### c. Example Controller Devices

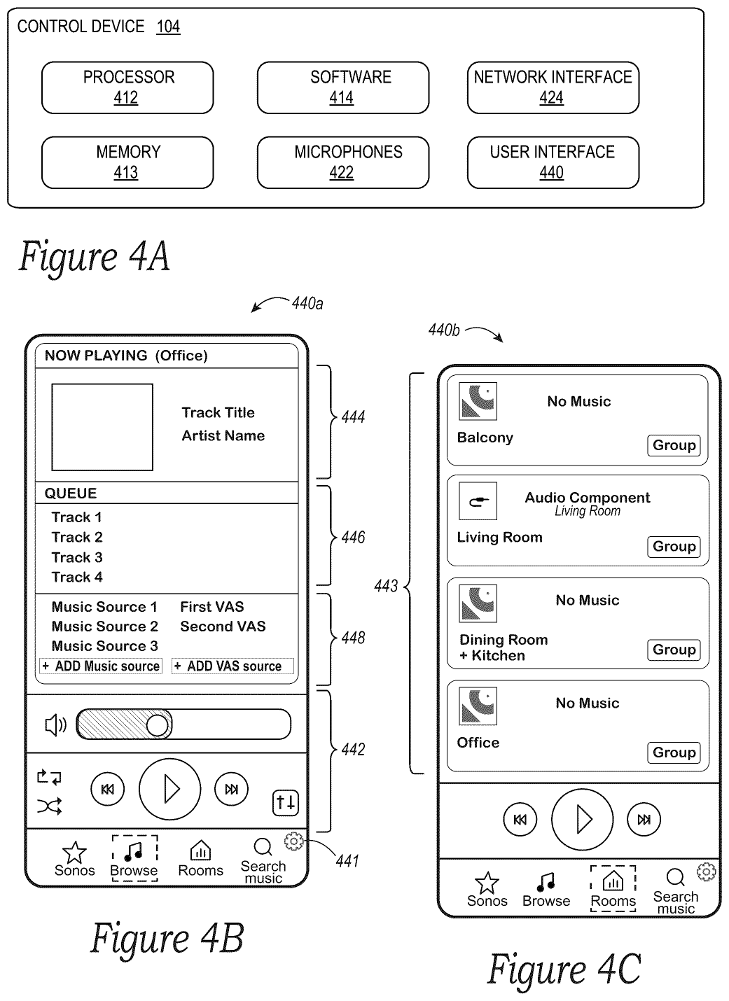

FIG. 4A is a functional block diagram illustrating certain aspects of a selected one of the controller devices 104 of the MPS 100 of FIG. 1A. Controller devices in accordance with several embodiments of the invention can be used in various systems, such as (but not limited to) an MPS as described in FIG. 1A. Such controller devices may also be referred to herein as a “control device” or “controller.” The controller device shown in FIG. 4A may include components that are generally similar to certain components of the network devices described above, such as a processor 412, memory 413 storing program software 414, at least one network interface 424, and one or more microphones 422. In one example, a controller device may be a dedicated controller for the MPS 100. In another example, a controller device may be a network device on which media playback system controller application software may be installed, such as for example, an iPhone™, iPad™ or any other smart phone, tablet, or network device (e.g., a networked computer such as a PC or Mac™).

The memory 413 of the controller device 104 may be configured to store controller application software and other data associated with the MPS 100 and/or a user of the system 100. The memory 413 may be loaded with instructions in software 414 that are executable by the processor 412 to achieve certain functions, such as facilitating user access, control, and/or configuration of the MPS 100. The controller device 104 may be configured to communicate with other network devices via the network interface 424, which may take the form of a wireless interface, as described above.

In one example, system information (e.g., such as a state variable) may be communicated between the controller device 104 and other devices via the network interface 424. For instance, the controller device 104 may receive playback zone and zone group configurations in the MPS 100 from a playback device, an NMD, or another network device. Likewise, the controller device 104 may transmit such system information to a playback device or another network device via the network interface 424. In some cases, the other network device may be another controller device.

The controller device 104 may also communicate playback device control commands, such as volume control and audio playback control, to a playback device via the network interface 424. As suggested above, changes to configurations of the MPS 100 may also be performed by a user using the controller device 104. The configuration changes may include adding/removing one or more playback devices to/from a zone, adding/removing one or more zones to/from a zone group, forming a bonded or merged player, separating one or more playback devices from a bonded or merged player, among others.

As shown in FIG. 4A, the controller device 104 may also include a user interface 440 that is generally configured to facilitate user access and control of the MPS 100. The user interface 440 may include a touch-screen display or other physical interface configured to provide various graphical controller interfaces, such as the controller interfaces 440a and 440b shown in FIGS. 4B and 4C. Referring to FIGS. 4B and 4C together, the controller interfaces 440a and 440b include a playback control region 442, a playback zone region 443, a playback status region 444, a playback queue region 446, and a sources region 448. The user interface as shown is just one example of an interface that may be provided on a network device, such as the controller device shown in FIG. 4A, and accessed by users to control a media playback system, such as the MPS 100. Other user interfaces of varying formats, styles, and interactive sequences may alternatively be implemented on one or more network devices to provide comparable control access to a media playback system.

The playback control region 442 (FIG. 4B) may include selectable icons (e.g., by way of touch or by using a cursor) that, when selected, cause playback devices in a selected playback zone or zone group to play or pause, fast forward, rewind, skip to next, skip to previous, enter/exit shuffle mode, enter/exit repeat mode, enter/exit cross fade mode, etc. The playback control region 442 may also include selectable icons that, when selected, modify equalization settings and/or playback volume, among other possibilities.

The playback zone region 443 (FIG. 4C) may include representations of playback zones within the MPS 100. The playback zones regions 443 may also include a representation of zone groups, such as the Dining Room+Kitchen zone group, as shown. In some embodiments, the graphical representations of playback zones may be selectable to bring up additional selectable icons to manage or configure the playback zones in the MPS 100, such as a creation of bonded zones, creation of zone groups, separation of zone groups, and renaming of zone groups, among other possibilities.

For example, as shown, a “group” icon may be provided within each of the graphical representations of playback zones. The “group” icon provided within a graphical representation of a particular zone may be selectable to bring up options to select one or more other zones in the MPS 100 to be grouped with the particular zone. Once grouped, playback devices in the zones that have been grouped with the particular zone will be configured to play audio content in synchrony with the playback device(s) in the particular zone. Analogously, a “group” icon may be provided within a graphical representation of a zone group. In this case, the “group” icon may be selectable to bring up options to deselect one or more zones in the zone group to be removed from the zone group. Other interactions and implementations for grouping and ungrouping zones via a user interface are also possible. The representations of playback zones in the playback zone region 443 (FIG. 4C) may be dynamically updated as playback zone or zone group configurations are modified.

The playback status region 444 (FIG. 4B) may include graphical representations of audio content that is presently being played, previously played, or scheduled to play next in the selected playback zone or zone group. The selected playback zone or zone group may be visually distinguished on a controller interface, such as within the playback zone region 443 and/or the playback status region 444. The graphical representations may include track title, artist name, album name, album year, track length, and/or other relevant information that may be useful for the user to know when controlling the MPS 100 via a controller interface.

The playback queue region 446 may include graphical representations of audio content in a playback queue associated with the selected playback zone or zone group. In some embodiments, each playback zone or zone group may be associated with a playback queue comprising information corresponding to zero or more audio items for playback by the playback zone or zone group. For instance, each audio item in the playback queue may comprise a uniform resource identifier (URI), a uniform resource locator (URL), or some other identifier that may be used by a playback device in the playback zone or zone group to find and/or retrieve the audio item from a local audio content source or a networked audio content source, which may then be played back by the playback device.

In one example, a playlist may be added to a playback queue, in which case information corresponding to each audio item in the playlist may be added to the playback queue. In another example, audio items in a playback queue may be saved as a playlist. In a further example, a playback queue may be empty, or populated but “not in use” when the playback zone or zone group is playing continuously streamed audio content, such as Internet radio that may continue to play until otherwise stopped, rather than discrete audio items that have playback durations. In an alternative embodiment, a playback queue can include Internet radio and/or other streaming audio content items and be “in use” when the playback zone or zone group is playing those items. Other examples are also possible.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue or may be associated with a new playback queue that is empty or contains audio items from the playback queue associated with the established zone group before the established zone group was ungrouped. Similarly, the resulting second playback zone may be re-associated with the previous second playback queue or may be associated with a new playback queue that is empty or contains audio items from the playback queue associated with the established zone group before the established zone group was ungrouped. Other examples are also possible.

With reference still to FIGS. 4B and 4C, the graphical representations of audio content in the playback queue region 446 (FIG. 4B) may include track titles, artist names, track lengths, and/or other relevant information associated with the audio content in the playback queue. In one example, graphical representations of audio content may be selectable to bring up additional selectable icons to manage and/or manipulate the playback queue and/or audio content represented in the playback queue. For instance, a represented audio content may be removed from the playback queue, moved to a different position within the playback queue, or selected to be played immediately, or after any currently playing audio content, among other possibilities. A playback queue associated with a playback zone or zone group may be stored in a memory on one or more playback devices in the playback zone or zone group, on a playback device that is not in the playback zone or zone group, and/or some other designated device. Playback of such a playback queue may involve one or more playback devices playing back media items of the queue, perhaps in sequential or random order.

The sources region 448 may include graphical representations of selectable audio content sources and/or selectable voice assistants associated with a corresponding VAS. The VASes may be selectively assigned. In some examples, multiple VASes, such as AMAZON's Alexa, MICROSOFT's Cortana, etc., may be invokable by the same NMD. In some embodiments, a user may assign a VAS exclusively to one or more NMDs. For example, a user may assign a first VAS to one or both of the NMDs 102a and 102b in the Living Room shown in FIG. 1A, and a second VAS to the NMD 103f in the Kitchen. Other examples are possible.

### d. Example Audio Content Sources

The audio sources in the sources region 448 may be audio content sources from which audio content may be retrieved and played by the selected playback zone or zone group. One or more playback devices in a zone or zone group may be configured to retrieve for playback audio content (e.g., according to a corresponding URI or URL for the audio content) from a variety of available audio content sources. In one example, audio content may be retrieved by a playback device directly from a corresponding audio content source (e.g., via a line-in connection). In another example, audio content may be provided to a playback device over a network via one or more other playback devices or network devices. As described in greater detail below, in some embodiments, audio content may be provided by one or more media content services.

Example audio content sources may include a memory of one or more playback devices in a media playback system such as the MPS 100 of FIG. 1, local music libraries on one or more network devices (e.g., a controller device, a network-enabled personal computer, or a networked-attached storage (“NAS”)), streaming audio services providing audio content via the Internet (e.g., cloud-based music services), or audio sources connected to the media playback system via a line-in input connection on a playback device or network device, among other possibilities.

In some embodiments, audio content sources may be added or removed from a media playback system such as the MPS 100 of FIG. 1A. In one example, an indexing of audio items may be performed whenever one or more audio content sources are added, removed, or updated. Indexing of audio items may involve scanning for identifiable audio items in all folders/directories shared over a network accessible by playback devices in the media playback system and generating or updating an audio content database comprising metadata (e.g., title, artist, album, track length, among others) and other associated information, such as a URI or URL for each identifiable audio item found. Other examples for managing and maintaining audio content sources may also be possible.

### III. Example Wireless Chargers for Playback Devices

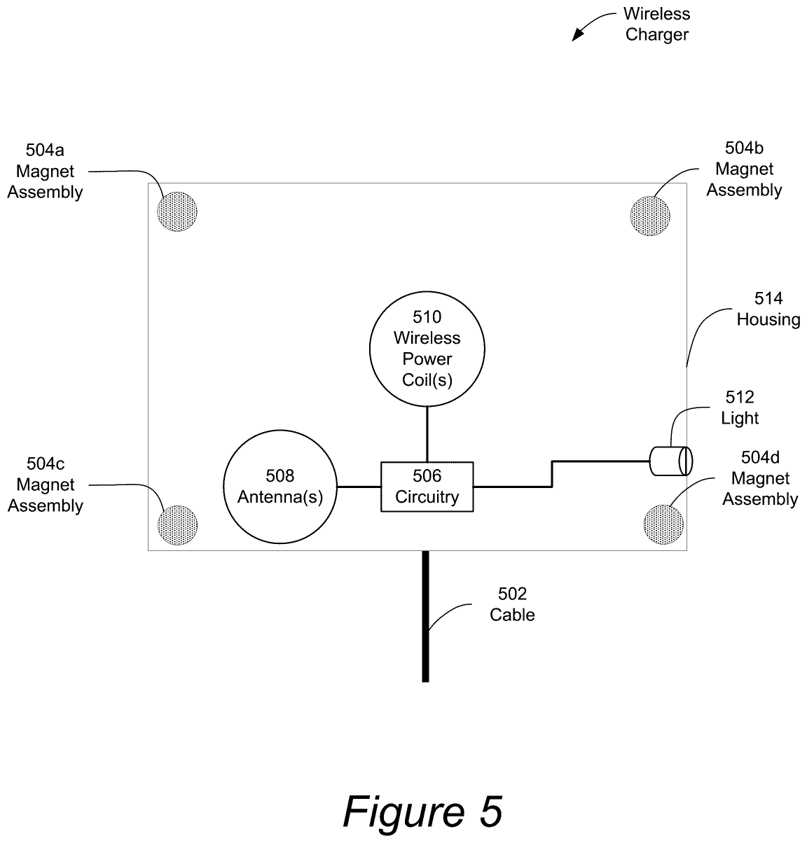

As discussed above, a wireless charger (or any other type of accessory) for a playback device may comprise one or more magnet assemblies to facilitate proper alignment of the wireless charger with the playback device in addition to enable wireless charging in multiple different orientations of the playback device. FIG. 5 is a block diagram of such a wireless charger 500. As shown, the wireless charger 500 comprises a power input port (e.g., comprising a cable such as cable 502 and/or a port configured to couple to a cable such as cable 502) and a housing 514. The housing 514 at least partially encloses one or more magnet assemblies 504 (shown as magnet assemblies 504a-504b), circuitry 506, antenna(s) 508, wireless power coil(s) 510, and light(s) 512.

The cable 502 may comprise, for example, one or more conductors configured to electrically couple one or more components of the wireless charger 500 (e.g., the circuitry 506, the wireless power coil(s) 510, the antenna(s) 508, and/or the light(s) 512) to an external power source. For example, the cable 502 may receive power from a power adapter that is plugged into a wall outlet. In this example, the power adapter may convert the alternating current (AC) power from the wall outlet into direct current (DC) power that may pass along the cable 502. The cable 502 may be implemented as, for example, a Universal Serial Bus (USB) cable such as a USB Type-A cable or Type-C cable. The cable 502 may be integrated with the wireless charger 500 (e.g., a captured USB cable such as a captured USB Type-A cable or a captured USB Type-C cable) or separable from the wireless charger 500 (e.g., the cable 502 may be removable coupled to a port on the wireless charger 500).

The circuitry 506 may be configured to receive power from the power input (e.g., from the cable 502) and cause the wireless charger 500 to perform one or more of the following functions: (1) detect the presence of a device capable of receive power wireless from the wireless charger; (2) transmit power wirelessly via the wireless power coil(s) 510 to a device (e.g., a detected device) capable of receiving power wirelessly from the wireless charger; (3) transmit a wireless signal via the antenna(s) 508 (e.g., to an external device, such as the external device receiving power wirelessly); (4) detect one or more operational faults of the wireless charger 500; and/or (5) output (e.g., using the light(s) 512) an indication that at least one fault has occurred in the wireless charger and/or a status of the wireless charger (e.g., charging, not charging, etc.).

In some implementations, the circuitry 506 may be configured to cause the wireless charger 500 to detect the presence of a device (e.g., a playback device) capable of receiving power wireless from the wireless charger. After detection of the presence of the device, the circuitry 506 may cause the wireless charger 500 to begin transferring power wirelessly to the device using the wireless power coil(s) 510. Also after detection of the presence of the device (e.g., and/or while the wireless charger 500 is transferring power wirelessly to the device), the circuitry 506 may cause the wireless charger 500 to transmit a wireless signal using the antennas 508. The wireless signal may contain an identifier that is associated with the wireless charger 500 (e.g., unique to the wireless charger 500 and/or associated with a particular class of device that the wireless charger 500 belongs, such as a first-party wireless charger (e.g., with a particular maximum power rating)). In turn, the identifier may be detected by the device and employed by the device to identify (e.g., uniquely identify) which wireless charger 500 the device (e.g. playback device) is in contact-with. Such information may be employed by a playback device to trigger one or more operations (e.g., pre-defined by a user and/or defined by the media playback system) as described in more detail below. For example, a playback device may automatically join a synchrony group comprising one or more other players when the playback device detects an identifier associated with a particular wireless charger. Conversely, the playback device may automatically leave the synchrony group when removed from the particular wireless charger.

In some implementations, the circuitry 506 may cause the wireless charger 500 to repeatedly transmit (e.g., repeatedly broadcast) the identifier (e.g., a unique identifier) associated with the wireless charger 500 for a period of time (e.g., a predetermined period of time) after detection of a specific event (e.g., detection of the presence of a device capable of being charged, start of wireless power transfer to the device, etc.). For example, the identifier may be transmitted periodically (e.g., every 100-500 milliseconds) or aperiodically for a fixed length of time (e.g., 30 seconds, 45 seconds, 60 seconds, etc.) after detection of the presence of a device capable of being charged. Once the fixed amount of time has expired, the repeated transmission of the identifier may stop. In other implementations, the circuitry 506 may cause the wireless charger 500 to repeatedly transmit (e.g., repeatedly broadcast) the identifier (e.g., a unique identifier) associated with the wireless charger 500 after detection of a first event (e.g., detection of the presence of a device capable of being charged, start of wireless power transfer to the device, etc.) until a second event is detected (e.g., wireless power transfer to the device stops, loss of presence of a device capable of being charged, etc.). In still yet other embodiments, the circuitry 506 may cause the wireless charger 500 to transmit (e.g., repeatedly broadcast) the identifier (e.g., a unique identifier) a fixed number of times (e.g., once, twice, thrice, etc.) after detection of a specific event (e.g., detection of the presence of a device capable of being charged, start of wireless power transfer to the device, etc.).

In some implementations, the wireless charger 500 may not establish a wireless connection with a device while transmitting the identifier. For example, the wireless charger 500 may incorporate the identifier into a broadcast message that can be directly received by a device without requiring a formal connection. In this example, the broadcast message may omit an address for a specific target device. Thus, the wireless charger 500 may not require a wireless connection to the device in order to successfully transmit the identifier. In other implementations, the wireless charger 500 may actually establish a connection with the device and transmit the identifier as part of one or more messages over the connection (e.g., addressed to the device).

By only transmitting the identifier for specific periods of time (e.g., a fixed period of time after some event and/or until detection of another event), the probability that a playback device can successfully disambiguate different wireless chargers is advantageously improved. For example, a user may have multiple wireless chargers positioned near each other and multiple playback devices capable of being charged by the wireless charger. In this example, having both wireless chargers transmitting their identifiers at the same time may frustrate unique identification of the specific wireless charger 500 that a playback device is being charged by. By time-bounding the transmission of the identifier (e.g., by a start and stop event, by expiration of a fixed period of time, etc.), the probability that two nearby wireless chargers are simultaneously transmitting their respective identifiers is advantageously reduced.

In some implementations, the transmit power of the wireless signal comprising the identifier may be modified dynamically. For example, the circuitry 506 may comprise one or more of the following: (1) resistive pi network, (2) swappable passive components, and/or (3) attenuators that may be adjusted to modify the transmit power of the wireless signal. In another example, the circuitry 506 may dynamically adjust the transmit power by directly modifying the power level of the wireless signal output by a radio. The transmit power of the wireless signal may be dynamically modified for any of a variety of reasons. For example, the transmit power of the wireless signal may be reduced to reduce the range of the wireless signal and/or reduce interference with other wireless signals in the same or similar frequency band.

It should be appreciated that the circuitry 506 may comprise any of a variety of different circuitry to perform the one or more functions described above. For example, the circuitry 506 may comprise one or more of the following: (1) one or more wireless radios; (2) one or more power conversion circuits; and/or (3) one or more wireless power transfer circuits.

The wireless power coil(s) 510 may be configured to facilitate wireless power transfer to an external device, such as a playback device. The wireless power coil(s) 510 may comprise one or more inductive coils electrically coupled to the circuitry 506.

The antennas 508 may be configured to facilitate transmission of one or more wireless signals (e.g., wireless signal(s) containing an identifier associated with the wireless charger). The particular construction of the antenna(s) 508 may vary based on, for example, the type of wireless transmission supported. For example, the antenna(s) 508 may comprise a radio frequency (RF) antenna such as a BLUETOOTH antenna configured to support transmission of information consistent with one or more BLUETOOTH standards (e.g., BLUETOOTH Classic, BLUETOOTH LOW ENERGY (BLE), etc.). Additionally (or alternatively), the antenna(s) 508 may comprise at least one near field communication (NFC) antenna (e.g., comprising an NFC coil) configured to support transmission of information consistent with one or more NFC standards. In some implementations, one or more of the at least one NFC coil are concentric with one or more of the wireless power coil(s) 510. Such an implementation employing concentric NFC and wireless power coil(s) may advantageously reduce the minimum dimensions of the wireless charger 500. Further, employing NFC may advantageously reduce the likelihood of a nearby device not being charged by the wireless charger receiving the wireless signal (and/or the identifier associated with the wireless charger 500).

The light(s) 512 may be configured to emit light (e.g., based on signal(s) from the circuitry 506). The light(s) 512 may comprise, for example, one or more light-emitting diodes (LEDs). In some implementations, the light(s) 512 may be at least partially disposed within the housing 514 such that light(s) 512 are not visible to a user. For example, the light(s) 512 may be disposed entirely within the housing 514 proximate a surface (e.g., a lateral surface) of the housing 514. In this example, the light(s) 512 may be sufficiently bright to shine through the housing 514 when activated (e.g., illuminating a portion of the surface of the housing 514). In other examples, the light(s) 512 may only be partially enclosed by the housing 514 (and/or visible to the user). The light(s) 512 may comprise, for example, one or more status lights (e.g., indicating that the wireless charger is charging a device or not charging a device) and/or one or more fault lights (e.g., indicating a fault has occurred with the wireless charger).

The magnet assemblies 504a-d may facilitate proper alignment between the wireless charging 500 and a playback device. The magnet assemblies 504a-d may each comprise one or more magnets configured to generate an attractive force on one or more ferromagnetic materials (e.g., ferromagnetic plates) (and/or magnet assemblies) in the playback device. In some implementations, the magnet assemblies 504a-d may be positioned proximate one or more edges (e.g., corners) of the housing 514 of the wireless charger. In these implementations, the magnet assemblies 504a-d may be disposed between the outer edge(s) of the wireless power coil(s) 510 and a lateral side of the housing 514. By positioning the magnet assemblies 504a-d in such a fashion, the attractive force of the magnet assemblies 504a-d tends to align the playback device and the wireless charger 500 in a particular direction.

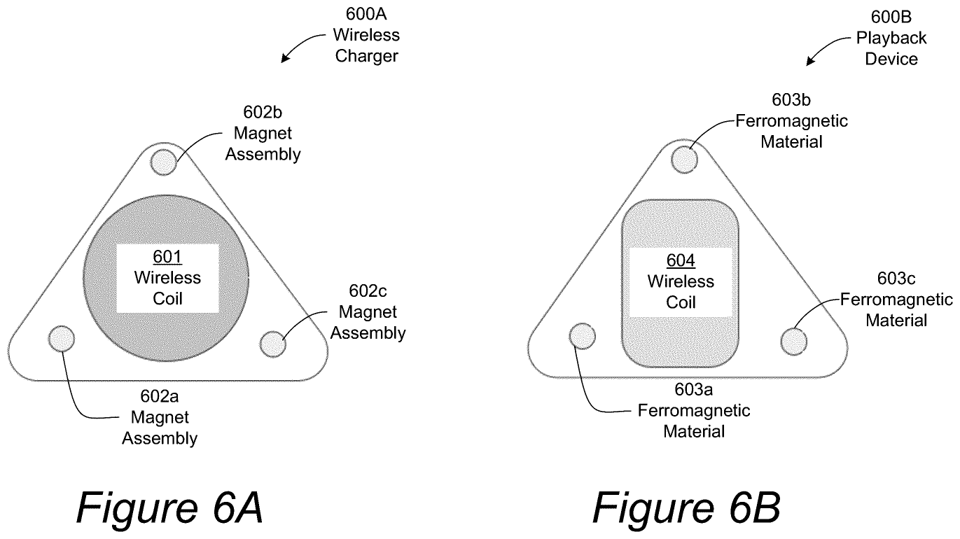

FIGS. 6A and 6B show an example placement of magnet assemblies 602a-c in a wireless charger 600A and respective ferromagnet materials 603a-c in a playback device 600B. FIG. 6A shows a top-down view of the wireless charger 600A that comprises a triangular housing including three corners. As shown, the wireless power coil 601 (e.g., a transmit coil) is disposed proximate the center of the housing and a magnet assembly 602 disposed proximate each of the three corners. FIG. 6B shows a top-down view of the playback device 600b that comprise a triangular housing comprising three corners. As shown, the wireless power coil 604 (e.g., a receive coil) is disposed proximate the center of the housing and a ferromagnetic material 603 is disposed proximate each of the three corners. By disposing the magnet assemblies 602a-c (and the respective ferromagnetic materials 603a-c) proximate the corners of the housing, the attractive force of the magnet assemblies 602a-c on the ferromagnetic materials 603a-c tends to align the corners of the housing of the wireless charger 600A with the corners of the housing of the playback device 600B. By employing magnet assemblies 602a-c proximate the corners of the housing, the wireless charger 600A (and the playback device 600B) may omit a magnet assembly (and respective ferromagnetic material) in the center of the wireless power coil 601 (and wireless power coil 604 respectively) as shown in FIGS. 6A and 6B.

It should be appreciated that various modifications may be made to the design shown in FIGS. 6A and 6B without departing from the scope of the present disclosure. For example, the housing may comprise more (or less) than three corners (e.g., a rectangular housing comprising four corners, a pentagonal housing comprising five corners, a circular housing having no corners). Further, the housing may comprise more (or fewer) magnet assemblies 602 and respective ferromagnetic materials 603. For instance, the wireless charger 600A may comprise an additional magnet assembly 602 in the center (or otherwise proximate the center) of the wireless power coil 601 and the playback device 600B may comprise a respective ferromagnetic material 603 in the center (or otherwise proximate the center) of the wireless power coil 604. Still yet further, the magnet assemblies 602 in the wireless charger 600A may be swapped with the respective ferromagnetic materials 603 in the playback device 600B. For example, the playback device 600B may comprise the magnet assemblies 602 and the wireless charger 600A may comprise the respective ferromagnetic materials 603. Still yet further, one or more of the ferromagnetic materials 603 in the playback device 600B may be replaced with additional magnet assemblies 602.

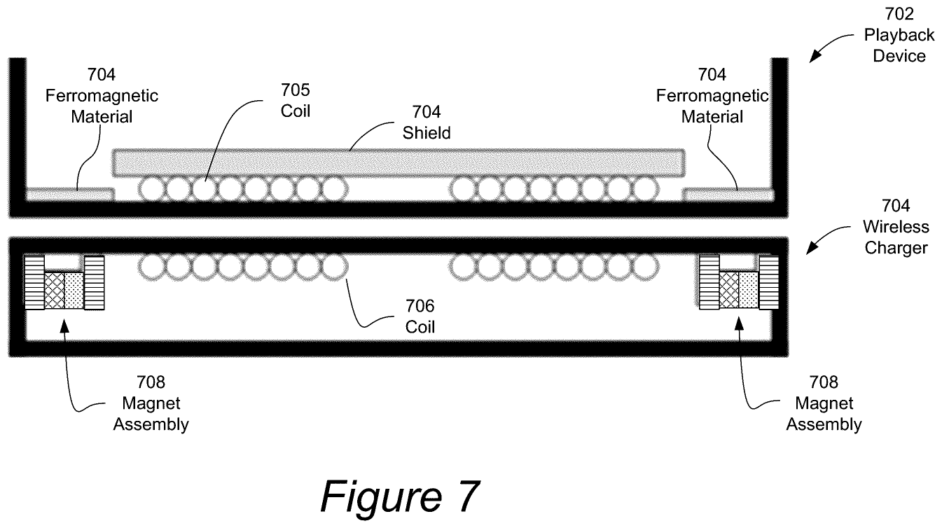

FIG. 7 shows a cross-sectional view of an example playback device 702 and a wireless charger 704. As shown, the playback device 702 comprises a coil 705 and ferromagnetic materials 704 (e.g., ferromagnetic plates such as metal plates) that are disposed proximate a mating surface (e.g., a bottom surface) of the playback device 702. The playback device 702 further comprises a shield 704 disposed above the coil 705. The wireless charger 704 comprises a coil 706 and magnet assemblies 708 disposed proximate a mating surface (e.g., a top surface) of the wireless charger 704. The magnet assemblies 708 may comprise one or more magnets and/or one or more ferromagnetic materials (e.g., metal plates). For example, the magnet assemblies 708 may comprise a magnet that is sandwiched by two metal plates. In this example, the magnet may be oriented such that the north and south poles of face lateral surface(s) of the wireless charger and each of the metal plates may be positioned vertically (e.g., perpendicular to the bottom surface and/or the top surface of the wireless charger 704) and in-contact with one of the poles of the magnet. For instance, the portion of the magnet assemblies 708 with a cross-hatched fill may indicate a first pole of a magnet, the portion of the magnet assemblies 708 with a dotted fill may indicate a second pole of a magnet that is different from the first pole, and the portions of the magnet assemblies 708 with a horizontal line fill may indicate a metal plate.

It should be appreciated that the playback device 702 and the wireless charger 704 may comprise additional components to facilitate communication as described herein. For example, the wireless charger 704 may comprise an NFC coil (e.g., that is concentric with the coil 706) and NFC circuitry (e.g., storing an identifier associated with the wireless charger) coupled to the NFC coil. In this example, the playback device 702 may comprise an NFC coil (e.g., the concentric with the coil 705) and NFC reader circuitry coupled to the NFC coil. The NFC reader circuitry in the playback device 702 may be configured to read (e.g., via the NFC coils) the NFC circuitry in the wireless charger 704 (e.g., to retrieve the identifier associated with the wireless charger).

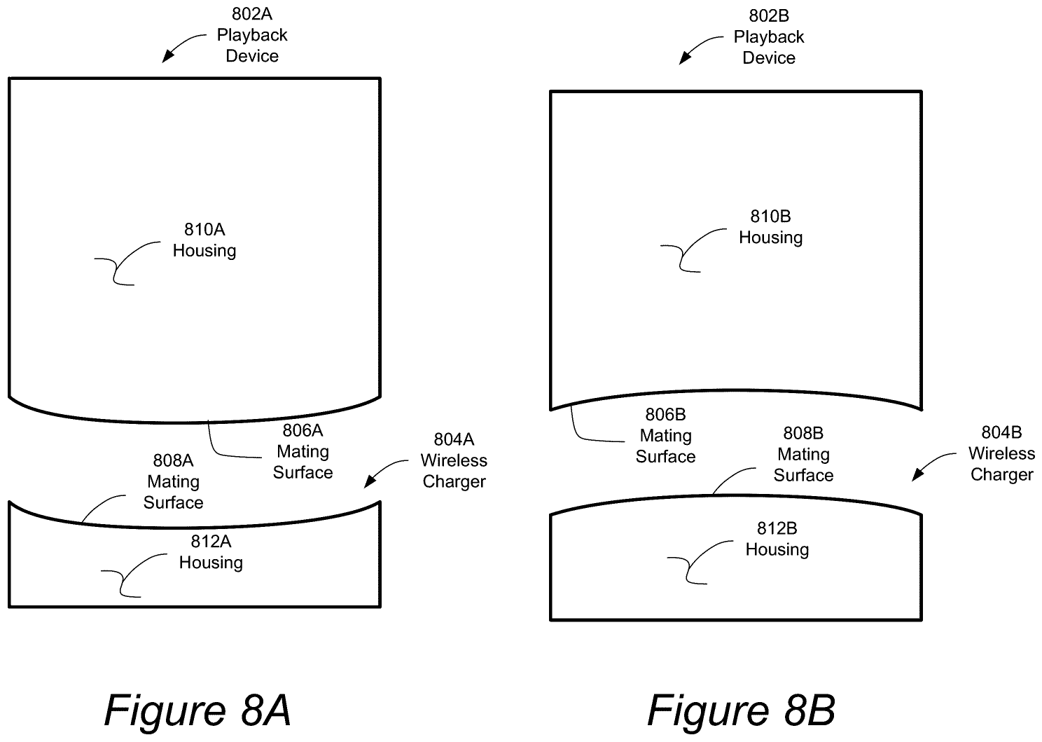

In some implementations, the mating surfaces of the wireless charger and the playback device may be implemented as non-flat surface. For example, the mating surface of the wireless charger and the playback device may be curved (or otherwise shaped) so as to further facilitate alignment of the wireless charger and the playback device. FIG. 8A shows an example of such mating surfaces for a playback device 802A and a wireless charger 804A that are designed to facilitate proper alignment of the playback device and the wireless charger. In particular, the housing 810A of the playback device 802A comprises a mating surface 806A that extends outward (e.g., is convex) towards the wireless charger 804A. Conversely, a housing 812A of the wireless charger 804A comprises a mating surface 808A that extends inward (e.g., is concave) towards a bottom surface of the wireless charger 804A to receive the portion of the mating surface 806A that extends towards the wireless charger 804A.

FIG. 8B shows another example of such mating surfaces for a playback device 802B and a wireless charger 804B that are designed to facilitate proper alignment of the playback device 802B and the wireless charger 804B. In particular, the housing 812B of the wireless charger 804B comprises a mating surface 808B that extends outward (e.g., is convex) toward the playback device 802B. Conversely, a housing 810B of the playback device 802B comprises a mating surface 806B that extends inward (e.g., is concave) towards a top surface of the playback device 802B to receive the portion of the mating surface 808B that extends towards the playback device 802B.

It should be appreciated that, in some implementations, the wireless chargers described herein may be compliant with one or more wireless charging standards such as the QI standard and/or the AIRFUEL standard.

### IV. Example Techniques for a Playback Device to Interact with a Base

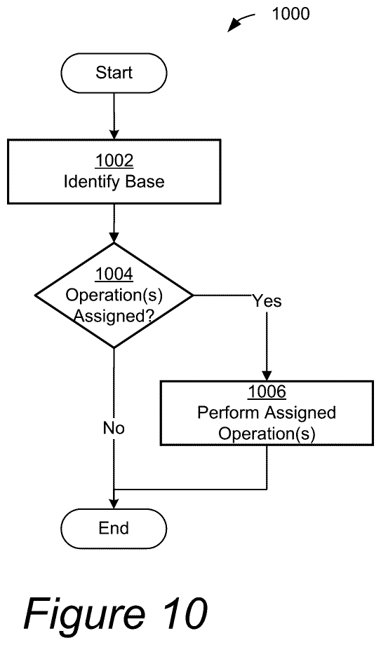

As discussed above, a playback device may, when placed on a base (e.g., a wireless charger as described herein), be able to obtain an identifier from that base and perform one or more operations based on that identifier. For instance, a join synchrony group operation may be associated with a particular base such that any playback device placed on the base automatically joins a particular synchrony group. FIG. 10 illustrates an example process 1000 by which a playback device interacts with a base. As shown, the process 1000 includes a block 1002 of identifying a base, a block 1004 of determining whether any operation(s) are assigned to the base, and a block 1006 of performing the assigned operation(s).

At block 1002, a playback device identifies a base onto which the playback device has been placed. For instance, referring to FIG. 7, the playback device 702 may identify wireless charger 704 when playback device 702 is placed upon wireless charger 704. An example media playback system (e.g., media playback system 100 of FIG. 1) may include a plurality of device bases. Identifying the device base may involve determining which particular base of this plurality that the playback device is currently placed on, which may facilitate determining which operation(s) (if any) the playback device should perform.

In some embodiments, a playback device may identify the device base by way of an identifier that uniquely identifies a particular base among devices of a media playback system (and possibly among all device bases from a particular manufacturer). Each device base may have such an identifier, which may be communicated to a playback device when that playback device is placed on the base. Within examples, the identifier may be stored in a data storage of the device base (e.g., in a memory of circuitry 506 in wireless charger 500), or the identifier may be coded into the device base (e.g., by way of a DIP switch or other logical circuitry integrated into the circuitry 506 of the wireless charger 500).

In some implementations, the identifier of the device base may be transmitted to the playback device using any of a variety of communication techniques including, for example, BLUETOOTH (e.g., BLUETOOTH LOW ENERGY) and/or NFC. For instance, while a playback device is placed on a device base, the device base may cause a radio interface to periodically transmit the identifier of device base to a corresponding radio interface of playback device. As noted above, a device base may use a near-field wireless communications interface, which may have a limited range such that the playback device is in range of the device base when the playback device is placed on or nearby the device base. Shielding the antenna of such a communications interface may further limit and orient its communications range, which may prevent communications between a playback device and a device base when the playback device is not on the device base.

Alternatively, the identifier of the device base may be communicated to the playback device via the charging circuit of the device base. For instance, a charging circuit may include a current or voltage signature (i.e., a pattern) that is unique as compared to other device bases. A playback device may use this unique signature to identify the charging base. Alternatively, a charging circuit may superimpose a communications signal onto the current delivered from the device base (e.g., current from the device base may include a high frequency communications signal).

At block 1004, the playback device may determine whether one or more operations have been assigned to the base identified in block 1002. To determine whether one or more operations have been assigned to the identified base, a playback device may refer to a state variable. A media playback system may maintain one or more state variables that indicate one or more correlations between device bases and respective operations that are assigned to those bases. The lack of a correlation between a given device base and one or more operations indicate that no operations have been assigned to the given device base, as such a correlation may be stored in the state variable upon one or more operation(s) being assigned to a device base.

In some embodiments, determining whether one or more operations have been assigned to the identified base may involve querying a database for operations assigned to an identifier received from the device base. For instance, playback device may query a database for one or more operations that are assigned to an identifier received from device base. In response, the playback device may receive an indication as to which (if any) operations are assigned to the identifier received from device base. The database may include data (e.g., one or more state variables) that indicates one or more correlations between device bases and respective operations that are assigned to those playback devices. Within examples, the database may be stored on the playback device itself, or on another playback device of the media playback system itself. Alternatively, the database might be stored on a server that is accessible to the media playback system (e.g., a server that provides a cloud service).

It should be appreciated that operation(s) may be assigned to a given device base in any of a variety of ways. In some instances, an operation may be assigned to a given device base by a user via a user interface (e.g., a user interface on the playback device itself or a control device in communication with the playback device). For example, a user may specify that anytime a playback device is placed on a particular base, that playback device should form a synchrony group with at least one other playback device. Additionally (or alternatively), the playback device may assign an operation to a given device base without direct user intervention. For example, a playback device may tune itself during audio playback while on a base based on self-sound detected by one or more microphones on the playback device (e.g., using AUTO TRUEPLAY by SONOS, Inc.). In this example, the playback device may assign one or more of the determined audio tuning settings to that base such that any playback devices placed on the base in the future may automatically adjust their audio tuning settings to suit the location where the base is placed.

If, at block 1004, one or more operations are identified that are assigned to the base, the playback device proceeds to block 1006 of performing the assigned operation(s). Otherwise, process 1000 ends. At block 1006, the playback device may perform any of a variety of operations. For example, a device may perform one or more of the following operations: (1) join an existing synchrony group; (2) leave an existing synchrony group; (3) form a new synchrony group; (4) change one or more settings, such as one or more settings associated with audio playback (e.g., volume, balance, equalization, etc.); and/or (5) modify a user interface (e.g., modify a functionality assigned to a user interface element (including deactivating/activating the user interface element), present an image of the detected accessory on a display screen, etc.).

### V. Conclusion

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only way(s) to implement such systems, methods, apparatus, and/or articles of manufacture.

It should be appreciated that references to transmitting information to particular components, devices, and/or systems herein should be understood to include transmitting information (e.g., messages, requests, responses) indirectly or directly to the particular components, devices, and/or systems. Thus, the information being transmitted to the particular components, devices, and/or systems may pass through any number of intermediary components, devices, and/or systems prior to reaching its destination. For example, a control device may transmit information to a playback device by first transmitting the information to a computing system that, in turn, transmits the information to the playback device. Further, modifications may be made to the information by the intermediary components, devices, and/or systems. For example, intermediary components, devices, and/or systems may modify a portion of the information, reformat the information, and/or incorporate additional information.

It should be appreciated that references to a first element being in proximity (and/or proximate) to a second element includes each of the following: (1) the first element being in direct contact with the second element; and (2) the first element being within a threshold distance (e.g., 5 centimeters, 3 centimeters, 1 centimeter, 8 millimeters, 5 millimeters, 1 millimeter, etc.) of the second element.

Similarly, references to receiving information from particular components, devices, and/or systems herein should be understood to include receiving information (e.g., messages, requests, responses) indirectly or directly from the particular components, devices, and/or systems. Thus, the information being received from the particular components, devices, and/or systems may pass through any number of intermediary components, devices, and/or systems prior to being received. For example, a control device may receive information from a playback device indirectly by receiving information from a cloud server that originated from the playback device. Further, modifications may be made to the information by the intermediary components, devices, and/or systems. For example, intermediary components, devices, and/or systems may modify a portion of the information, reformat the information, and/or incorporate additional information.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the forgoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### Example Features

(Feature 1) A wireless charger for a playback device, the wireless charger comprising: a power input; a housing at least partially enclosing: at least one wireless charging coil; at least one magnet assembly comprising a magnet (e.g., wherein the at least one magnet assembly is configured to facilitate alignment of a playback device with the wireless charger); at least one antenna; circuitry coupled to the power input, the at least one wireless charging coil, and the at least one antenna, wherein the circuitry is configured to: receive power via the power input; (e.g., detect a presence of a playback device comprising a wireless power receiver (e.g., a wireless power receiver that is compatible with the wireless charger)) (e.g., after detection of the presence of a playback device), cause power to be transmitted via the at least one wireless charging coil (e.g., to a playback device via the wireless power receiver in the playback device); and (e.g., after detection of the presence of a playback device), cause transmission of a wireless signal via the at least one antenna (e.g., to a playback device).

(Feature 2) The wireless charger of feature 1, wherein the housing comprises a plurality of corners.

(Feature 3) The wireless charger of feature 2, wherein one or more of the at least one magnet assembly is disposed proximate at least one of the plurality of corners.

(Feature 4) The wireless charger of feature 1, wherein the housing is a triangular housing comprising three corners including a first corner, a second corner, and a third corner.

(Feature 5) The wireless charger of feature 4, wherein the at least one magnet assembly comprises one or more of the following: a first magnet assembly disposed proximate the first corner, a second magnet assembly disposed proximate the second corner, or a third magnet assembly disposed proximate the third corner.

(Feature 6) The wireless charger of any of features 1-4, wherein the housing comprises a polymeric material.

(Feature 7) The wireless charger of feature 5, wherein the polymeric material comprises a plastic.

(Feature 8) The wireless charger of any of features 1-7, wherein the housing comprises a mating surface configured to engage a mating surface of a playback device.

(Feature 9) The wireless charger of feature 8, wherein the mating surface comprises a non-flat surface.

(Feature 10) The wireless charger of feature 9, wherein the non-flat surface comprises a concave surface.

(Feature 11) The wireless charger of feature 10, wherein the concave surface is configured to engage a convex surface of the wireless charger.

(Feature 12) The wireless charger of feature 9, wherein the non-flat surface comprises a convex surface.

(Feature 13) The wireless charger of feature 12, wherein the convex surface is configured to engage a concave bottom surface of the wireless charger.

(Feature 14) The wireless charger of any of features 1-13, wherein the at least one antenna comprises one of: a BLUETOOTH antenna, a WIFI antenna, or a near field communication (NFC) antenna.

(Feature 15) The wireless charger of feature 14, wherein the at least one antenna comprises an NFC antenna and wherein the NFC antenna comprises a coil that is concentric with one or more of the at least one wireless charging coil.

(Feature 16) The wireless charger of any of features 1-15, further comprising a light and wherein the circuitry is coupled to the light.

(Feature 17) The wireless charger of feature 16, wherein the circuitry is configured to detect at least one fault of the wireless charger and active the light after detection of the at least one fault.

(Feature 18) The wireless charger of feature 17, wherein the light is disposed within the housing such that the light is not visible to a user when not illuminated.

(Feature 19) The wireless charger of feature 17 or 18, wherein the light comprises a light-emitting-diode disposed entirely within the housing.

(Feature 20) The wireless charger of any of features 1-19, wherein the wireless signal comprises an identifier associated with the wireless charger.

(Feature 21) A system (e.g., an audio kit) comprising: a playback device comprising: a housing including a first mating surface; at least one ferromagnetic material (e.g., disposed proximate the first mating surface); and a wireless power receiver configured to receive power wirelessly, wherein the wireless power receiver is at least partially disposed in the housing; and a wireless charger for the playback device, the wireless charger comprising: a power input; a housing including a second mating surface configured to engage the first mating surface of the playback device, wherein the housing at least partially encloses: at least one wireless charging coil; at least one magnet assembly comprising a magnet (e.g., wherein the at least one magnet assembly is configured to facilitate alignment of the playback device with the wireless charger (e.g., by attracting the at least one ferromagnetic material disposed in the playback device)) (e.g., wherein one or more of the at least one magnet assembly are disposed proximate the second mating surface); at least one antenna; circuitry coupled to the power input, the at least one wireless charging coil, and the at least one antenna, wherein the circuitry is configured to: receive power via the power input; (e.g., detect a presence of the playback device) (e.g., after detection of the presence of the playback device), cause power to be transmitted via the at least one wireless charging coil (e.g., to a playback device via the wireless power receiver in the playback device); and (e.g., after detection of the presence of the playback device), cause transmission of a wireless signal via the at least one antenna (e.g., to the playback device).

(Feature 22) A wireless charger for a playback device comprising a compatible wireless power receiver, the wireless charger comprising: a power input; a housing at least partially enclosing: at least one wireless charging coil; a plurality of magnet assemblies each comprising a magnet, wherein the plurality of magnet assemblies are configured to facilitate alignment of the playback device with the wireless charger; at least one antenna; circuitry coupled to the power input, the at least one wireless charging coil, and the at least one antenna, wherein the circuitry is configured to: receive power via the power input; detect a presence of the playback device; after detection of the presence of the playback device, cause power to be transmitted via the at least one wireless charging coil to the playback device; and cause transmission of a wireless signal via the at least one antenna, wherein the wireless signal comprises an identifier associated with the wireless charger.

(Feature 23) The wireless charger of feature 22, wherein the housing comprises a plurality of corners.

(Feature 24) The wireless charger of feature 23, wherein at least one of the plurality of magnet assemblies is disposed proximate at least one of the plurality of corners.

(Feature 25) The wireless charger of feature 22, wherein the housing is a triangular housing comprising three corners including a first corner, a second corner, and a third corner.

(Feature 26) The wireless charger of feature 25, wherein the plurality of magnet assemblies comprises one or more of the following: a first magnet assembly disposed proximate the first corner, a second magnet assembly disposed proximate the second corner, or a third magnet assembly disposed proximate the third corner.

(Feature 27) The wireless charger of feature 22, wherein the housing comprises a mating surface configured to engage a mating surface of a playback device, wherein the mating surface comprises a non-flat surface.

(Feature 28) The wireless charger of feature 22, wherein the at least one antenna comprises a radio frequency (RF) antenna or a near field communication (NFC) antenna.

(Feature 29) The wireless charger of feature 22, wherein the at least one antenna comprises an NFC antenna and wherein the NFC antenna comprises a coil that is concentric with one or more of the at least one wireless charging coil.

(Feature 30) The wireless charger of feature 22, further comprising a light and wherein the circuitry is coupled to the light.

(Feature 31) The wireless charger of feature 30, wherein the circuitry is configured to detect at least one fault of the wireless charger and active the light after detection of the at least one fault.

(Feature 32) The wireless charger of feature 30, wherein the light is disposed entirely within the housing.

(Feature 33) A wireless charger for a device comprising a compatible wireless power receiver, the wireless charger comprising: an integrated Universal Serial Bus (USB) Type-C cable; a circular housing comprising a top surface, a bottom surface that is opposite the top surface, and a lateral surface disposed between the top surface and the bottom surface, wherein the top surface comprises a mating surface configured to engage a surface of the device, and wherein the circular housing at least partially encloses: at least one wireless charging coil having an outer edge; a plurality of magnets configured to facilitate alignment of the device with the wireless charger, wherein at least some of the plurality of magnets are disposed between the outer edge of the at least one wireless charging coil and the lateral surface of the circular housing; at least one near field communication (NFC) antenna comprising a coil, wherein the coil is concentric with one or more of the at least one wireless charging coil; circuitry coupled to the integrated USB Type-C cable, the at least one wireless charging coil, and the at least one NFC antenna, wherein the circuitry is configured to: receive power via the USB Type-C cable; detect a presence of the device; after detection of the presence of the device, cause power to be transmitted via the at least one wireless charging coil to the device; and cause transmission of a wireless signal via the at least one NFC antenna, wherein the wireless signal comprises an identifier associated with the wireless charger.

(Feature 34) The wireless charger of feature 33, wherein the housing comprises a polymeric material.

(Feature 35) The wireless charger of feature 33, wherein the at least some of the plurality of magnets are disposed within 1 centimeter of the lateral surface of the circular housing.

(Feature 36) The wireless charger of feature 33, wherein the mating surface comprises a non-flat surface.

(Feature 37) A system comprising: a device comprising a first housing including a first mating surface, wherein the first housing at least partially encloses: at least one ferromagnetic material; at least one wireless power receiver; at least one communication interface that is configured to facilitate communication via one or more data networks; at least one processor; at least one audio amplifier; at least one non-transitory computer-readable medium comprising program instructions that are executable by the at least one processor such that the device is configured to: after receipt of media content via the at least one communication interface, playback the media content using the at least one audio amplifier; and a wireless charger comprising a second housing including a second mating surface configured to engage the first mating surface of the device, the second housing at least partially encloses: at least one wireless charging coil; a plurality of magnets configured to facilitate alignment of the wireless charger with the device at least in part by attracting the at least one ferromagnetic material in the device; at least one antenna; circuitry coupled the at least one wireless charging coil and the at least one antenna, wherein the circuitry is configured to: detect a presence of the device; after detection of the presence of the device, cause power to be transmitted via the at least one wireless charging coil to the at least one wireless power receiver of the device; and cause transmission of a wireless signal via the at least one antenna, wherein the wireless signal comprises an identifier associated with the wireless charger.

(Feature 38) The system of feature 37, wherein the at least one ferromagnetic material is disposed proximate the first mating surface and wherein at least some of the plurality of magnets are disposed proximate the second mating surface.

(Feature 39) The system of feature 37, wherein the at least one non-transitory computer-readable medium further comprises program instructions that are executable by the at least one processor such that the device is configured to: after receipt of the identifier associated with the wireless charger, perform at least one operation based on the identifier.

(Feature 40) The system of feature 39, wherein the at least one operation comprises at least one of: form a synchrony group (e.g., form a new synchrony group), join a synchrony group (e.g., join an existing synchrony group), leave a synchrony group (e.g., leave an existing synchrony group), or modify one or more settings associated with audio playback (e.g., volume setting(s), equalization setting(s), etc.).

1. A playback device comprising:
a housing having at least one mating surface;
a wireless power receiver housed at least partially within the housing and configured to receive power from a compatible wireless charging base when the playback device is coupled to the wireless charging base via the at least one mating surface;
a radio interface housed at least partially within the housing and configured to facilitate communication via one or more wireless data networks;
a magnetic attachment assembly housed within the housing and disposed proximate the at least one mating surface, the magnetic attachment assembly being arranged to facilitate alignment of the at least one mating surface with a corresponding mating surface of the wireless charging base to support wireless charging of the playback device via the wireless charging base in multiple different orientations of the playback device;
at least one processor housed within the housing; and
at least one non-transitory computer-readable medium housed within the housing and comprising program instructions that are executable by the at least one processor to cause the playback device to:
detect that the playback device is coupled to the wireless charging base,
detect, via the radio interface, a wireless signal containing an identifier that uniquely identifies the wireless charging base,
determine, based on the identifier, whether one or more operations are assigned to the wireless charging base, and
perform, based on determining that at least one operation is assigned to the wireless charging base, the at least one operation while the playback device is coupled to the wireless charging base.

2. The playback device of claim 1, wherein to perform the at least one operation comprises to:
join an existing synchrony group that includes at least one other playback device; or
form a new synchrony group with the at least one other playback device.

3. The playback device of claim 2, further comprising:
one or more audio transducers housed at least partially within the housing;
wherein to perform the at least one operation comprises to play back, via the one or more audio transducers, audio content in synchrony with playback of the audio content by the at least one other playback device.

4. The playback device of claim 1, wherein to perform the at least one operation comprises to change one or more audio playback settings of the playback device.

5. The playback device of claim 4, wherein the one or more audio playback settings comprise one or more of a volume of playback, a balance setting, or an equalization setting.

6. The playback device of claim 1, further comprising:
a user interface including one or more user interface elements; and
wherein to perform the at least one operation comprises to modify a functionality assigned to at least one of the one or more user interface elements.

7. The playback device of claim 1, wherein to perform the at least one operation comprises to leave an existing synchrony group.

8. The playback device of claim 1, wherein to determine whether the one or more operations are assigned to the wireless charging base comprises to query a database to observe a state variable that indicates correlations between the one or more operations and the wireless charging base.

9. The playback device of claim 1, wherein the radio interface comprises at least one of a BLUETOOTH antenna or a near field communication (NFC) antenna; and wherein to detect the wireless signal comprises to detect the wireless signal via the BLUETOOTH antenna or the NFC antenna.

10. The playback device of claim 9, wherein the magnetic attachment assembly comprises one or more magnet assemblies and/or one or more ferromagnetic materials.

11. A media playback system comprising:
a playback device comprising a first housing including a first mating surface, wherein the first housing at least partially encloses:
at least one ferromagnetic material,
a wireless power receiver,
a wireless communication interface configured to facilitate communication via one or more wireless data networks, the wireless communication interface including at least one first antenna,
at least one processor, and
at least one audio transducer; and
a wireless charger comprising a second housing including a second mating surface configured to engage the first mating surface of the playback device, wherein the second housing at least partially encloses:
at least one wireless charging coil,
a plurality of magnets configured to facilitate alignment of the wireless charger with the playback device at least in part by attracting the at least one ferromagnetic material in the playback device,
at least one second antenna, and
circuitry coupled the at least one wireless charging coil and the at least one second antenna, wherein the circuitry is configured to:
detect a presence of the playback device;
after detection of the presence of the playback device,
cause power to be transmitted via the at least one wireless charging coil to the at least one wireless power receiver of the playback device, and
cause transmission of a wireless signal via the at least one antenna, wherein the wireless signal comprises an identifier that uniquely identifies the wireless charger;
wherein the playback device further comprises:
at least one non-transitory computer-readable medium housed within the first housing and comprising program instructions that are executable by the at least one processor to cause the playback device to:
detect the identifier,
determine, based on the identifier, whether one or more operations are assigned to the wireless charging base, and
perform, based on determining that at least one operation is assigned to the wireless charging base, the at least one operation while the playback device is coupled to the wireless charging base.

12. The media playback system of claim 11, wherein the at least one ferromagnetic material is disposed proximate the first mating surface and wherein at least some of the plurality of magnets are disposed proximate the second mating surface.

13. The media playback system of claim 11, wherein the at least one first antenna is one of a first BLUETOOTH antenna or a first near field communication (NFC) antenna; and
wherein the at least one second antenna is one of a second BLUETOOTH antenna or a second NFC antenna.

14. The media playback system of claim 11, wherein to perform the at least one operation comprises to cause the playback device to:
join an existing synchrony group that includes at least one other playback device; or
form a new synchrony group with the at least one other playback device.

15. The media playback system of claim 14, wherein the playback device further comprises one or more audio transducers housed at least partially within the housing; and
wherein to perform the at least one operation comprises to play back, via the one or more audio transducers, audio content in synchrony with playback of the audio content by the at least one other playback device.

16. The media playback system of claim 11, wherein to perform the at least one operation comprises to change one or more audio playback settings of the playback device.

17. The media playback system of claim 16, wherein the one or more audio playback settings comprise one or more of a volume of playback, a balance setting, or an equalization setting.

18. The media playback system of claim 11, further comprising:
a device comprising a user interface including a display screen;
wherein to perform the at least one operation comprises to cause the an image of the wireless charger to be displayed on the display screen.

19. The media playback system of claim 11, wherein to perform the at least one operation comprises to cause the playback device to leave an existing synchrony group.

20. The media playback system of claim 11, wherein the wireless charger further comprises a light; and
wherein the circuitry is coupled to the light and further configured to:
detect one or more operational faults of the wireless charger, and
cause the light to indicate that at least one of the one or more operational faults has occurred.
